(19) United States
(12) Patent Application Publication
(10) Pub. No.: US 2024/0343906 A1
(43) Pub. Date: Oct. 17, 2024

(54) POLOXAMER-STABILIZED REAGENTS

(71) Applicant: Promega Corporation, Madison, WI (US)

(72) Inventors: Thomas Andrew KIRKLAND, Madison, WI (US); Thomas P. SMITH, Madison, WI (US); Elizabeth VU, Madison, WI (US); Connor FITZGERALD, Madison, WI (US); Chao GAO, Madison, WI (US)

(21) Appl. No.: 18/634,518

(22) Filed: Apr. 12, 2024

Related U.S. Application Data
(60) Provisional application No. 63/495,690, filed on Apr. 12, 2023.

(51) Int. Cl. C09B 11/24; C08L 71/02; C09K 11/06

(52) U.S. Cl. CPC C09B 11/24; C08L 71/02; C09K 11/06

(57) ABSTRACT

Provided herein are biotechnology reagents provided with a poloxamer excipient. In particular, haloalkane-linked fluorophores are provided in solution or a lyophilized formulation with a poloxamer that allows for storage, accurate dispensing/measurement, reconstitution, and addition to complex biological samples without the requirement of organic solvents.

### CROSS-REFERENCE TO RELATED APPLICATION

The present invention claims priority to U.S. Provisional Patent Application Ser. No. 63/495,690, filed Apr. 12, 2023, which is hereby incorporated by reference in its entirety.

### FIELD

Provided herein are biotechnology reagents provided with a poloxamer excipient. In particular, haloalkane-linked fluorophores are provided in solution or a lyophilized formulation with a poloxamer that allows for storage, accurate dispensing/measurement, reconstitution, and addition to complex biological samples without the requirement of organic solvents.

### BACKGROUND

HALOTAG is a modified haloalkane dehalogenase designed to covalently bind to haloalkane (e.g., chloroalkane) ligands (Los et al. ACS Chem. Biol. 2008, 3, 6, 373-382; incorporated by reference in its entirety). HALOTAG ligands must be able to be stored, reconstituted, and added to various systems (e.g., cells, animals, etc.) in a convenient and non-toxic manner. Currently, HALOTAG ligands are supplied either as solids or DMSO solutions. Although widely used, these formulations present issues with stability, storage, ability to accurately dispense (particularly when very small amounts are required), and the requirement for organic solvents to be used, which can be problematic for biological systems, that is augmented in animal models. What is needed is a lyophilized formulation of HALOTAG ligands that are stable for storage and allows for simple reconstitution in aqueous buffers in a wide range of concentrations that allows for addition to anywhere from simple biological samples to animal models systems without the need for organic solvents.

### SUMMARY

Provided herein are biotechnology reagents provided with a poloxamer excipient. In particular, haloalkane-linked fluorophores are provided in solution or a lyophilized formulation with a poloxamer that allows for storage, accurate dispensing/measurement, reconstitution, and addition to complex biological samples without the requirement of organic solvents.

In some embodiments, provided herein are compositions comprising: (a) a compound comprising the formula R-linker-A-X, wherein R is a small molecule fluorophore, wherein the linker is a multiatom straight or branched chain, A is (CH₂)₄₋₂₀, and X is a halide; and (b) a poloxamer polymer.

In some embodiments, the fluorophore is a small molecule (e.g., molecular weight less than 3,000 daltons, <2,500 daltons, <2,000 daltons, <1,500 daltons, <1,000 daltons, <900 daltons, <800 daltons, <700 daltons, <600 daltons). In particular embodiments, the fluorophore is a hydrophobic small molecule that is of low solubility in aqueous solutions. In some embodiments, not more than 1 mM or less (e.g., 1 mM, 800 μM, 600 μM, 400 μM, 200 μM, 100 μM, 75 μM, 50 μM, 40 μM, 30 μM, 20 μM, 10 μM, 5 μM, or less) of the fluorophore (e.g., when linked to a haloalkane) is soluble in aqueous solution in the absence of poloxamer. In some embodiments, not more than 200 μM or less (e.g., 200 μM, 100 μM, 75 μM, 50 M, 40 M, 30 μM, 20 μM, 10 μM, 5 μM, or less) of the fluorophore (e.g., when linked to a haloalkane) is soluble in aqueous solution in the absence of poloxamer. In some embodiments, not more than 2 μM or less (e.g., 2 μM, 1 μM, 0.75 μM, 0.50 μM, 0.1 μM, or less) or the fluorophore (e.g., when linked to a haloalkane) is soluble in aqueous solution in the absence of poloxamer. In some embodiments, in the presence of poloxamer the fluorophore (e.g., when linked to a haloalkane) is soluble in aqueous solutions at a concentration of 0.1 μM, 0.2 μM, 0.5 μM, 1 μM, 2 μM, 5 μM, 10 μM, 20 μM, 30 μM, 40 μM, 50 μM, 75 μM, 100 μM, 150 μM, 200 μM, 500 μM, 750 μM, 1 mM, 1.5 mM, 2 mM, or more, or ranges therebetween. In some embodiments, for fluorophores with particularly low solubility (e.g., when linked to a haloalkane) in the presence of poloxamer the compound is soluble in aqueous solutions at a concentration of at least 1 nM (e.g., 1 nM, 2 nM, 3 nM, 4 nM, 5 nM, 6 nM, 7 nM, 8 nM, 9 nM. 10 nM, 20 nM, 30 nM, 40 nM, 50 nM 0.1 μM, 0.2 μM, 0.5 μM, 1 μM, 2 μM, 5 μM, 10 μM, 20 μM, 30 μM, 40 μM, 50 μM, 75 μM, 100 μM, 150 μM, 200 μM, 500 μM, 750 μM, 1 mM, 1.5 mM, 2 mM, or more, or ranges therebetween).

In some embodiments, the fluorophore is a rhodol or rhodamine dye (Beija et al. Chem. Soc. Rev., 2009, 38, 2410-2433; incorporated by reference in its entirety) or a variant or derivative thereof. In some embodiments, the rhodol or rhodamine dye is selected from:

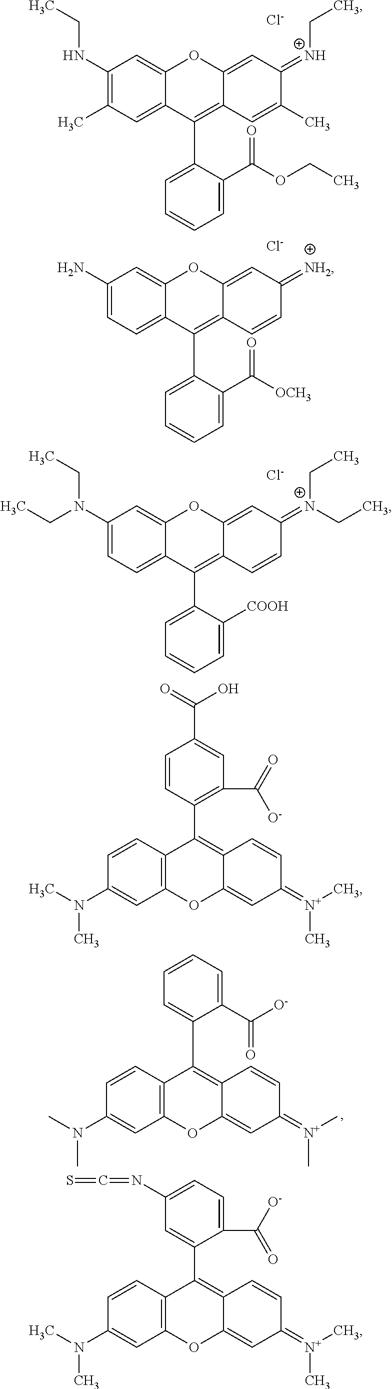

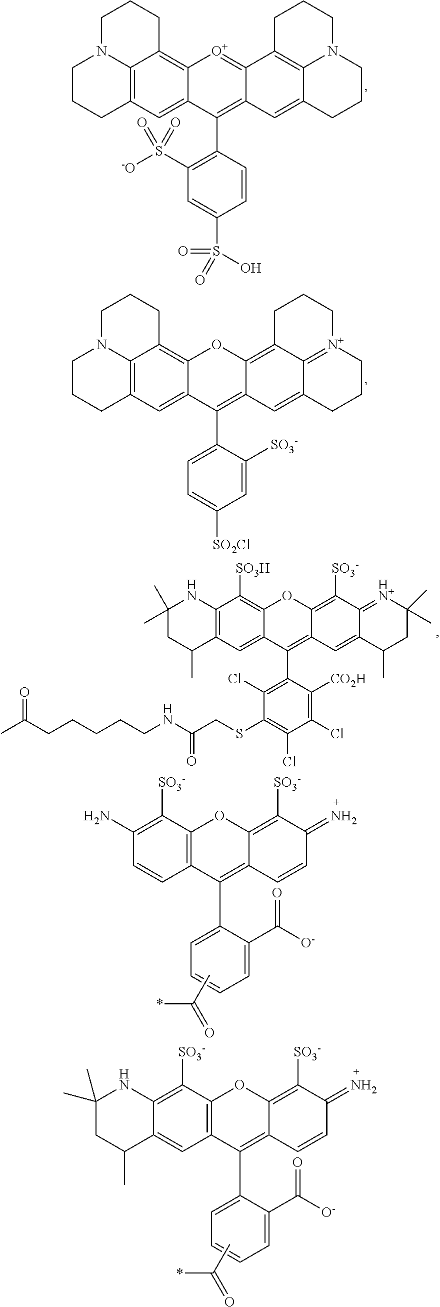

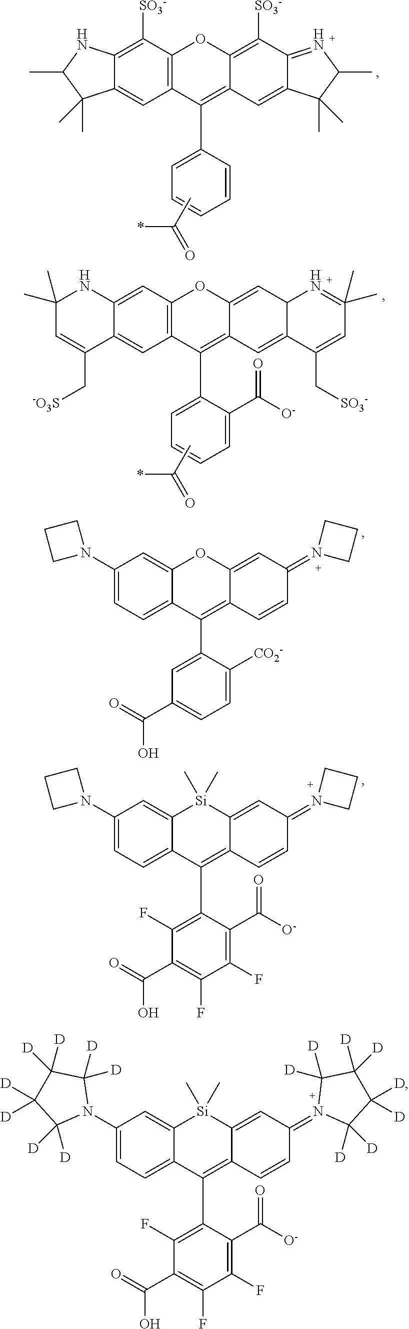

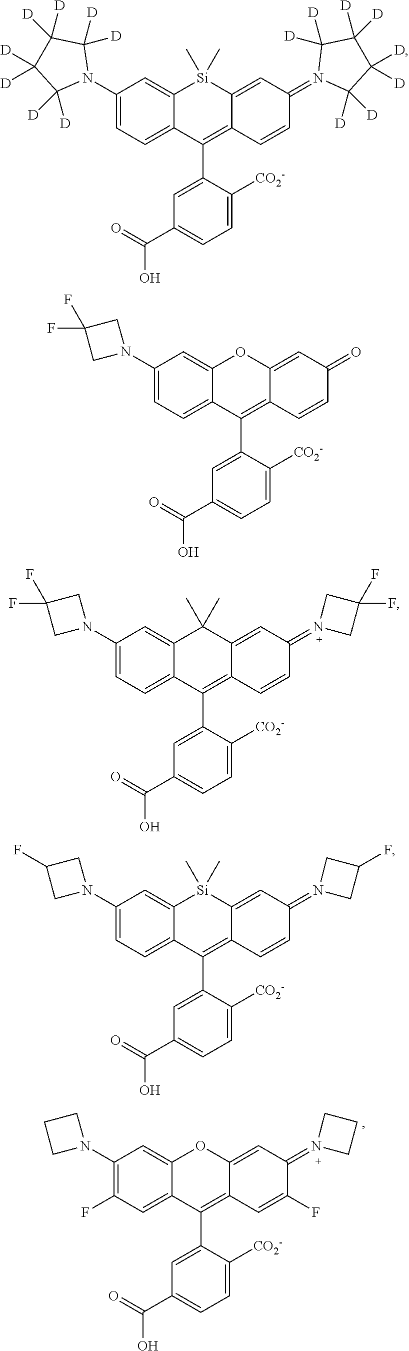

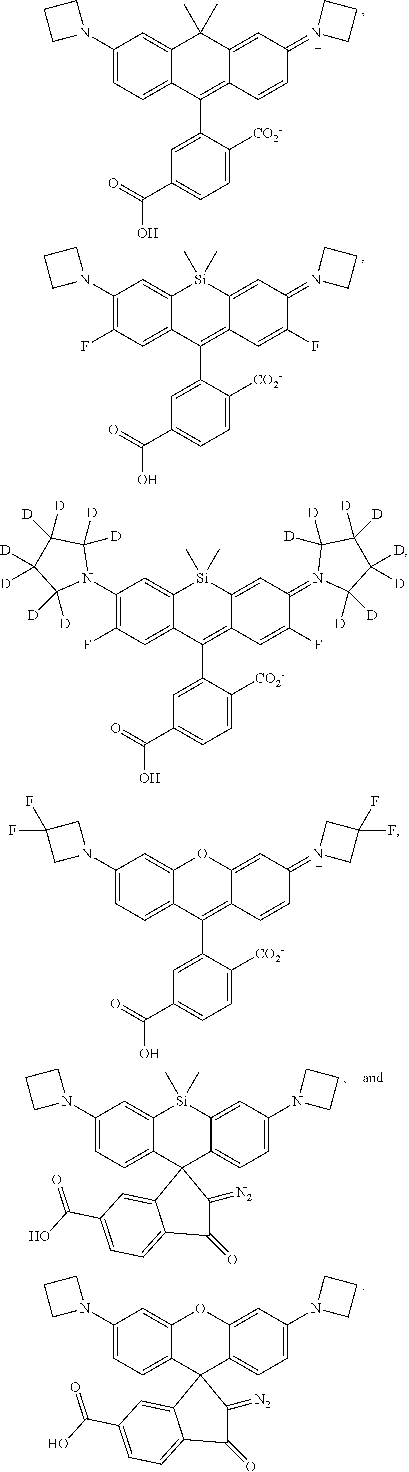

In some embodiments, the fluorophore is a rhodamine.

In some embodiments, the linker is a multiatom straight or branched chain including C, N, S, or O that optionally comprises one or more rings. In some embodiments, the linker comprises a cleavable moiety. In some embodiments, the cleavable moiety is selected from an allyl-heteroatom group and a propargyl-heteroatom group.

In some embodiments, the poloxamer is selected from poloxamer 101, poloxamer 105, poloxamer 108, poloxamer 122, poloxamer 123, poloxamer 124, poloxamer 181, poloxamer 182, poloxamer 183, poloxamer 184, poloxamer 185, poloxamer 188, poloxamer 212, poloxamer 215, poloxamer 217, poloxamer 231, poloxamer 234, poloxamer 235, poloxamer 237, poloxamer 238, poloxamer 282, poloxamer 284, poloxamer 288, poloxamer 331, poloxamer 333, poloxamer 334, poloxamer 335, poloxamer 338, poloxamer 401, poloxamer 402, poloxamer 403, and poloxamer 407. In some embodiments, the poloxamer is poloxamer 407.

In some embodiments, compositions herein further comprise a buffer, a surfactant, a reducing agent, a salt, a radical scavenger, a protein, or any combination thereof. In some embodiments, the buffer is selected from a phosphate buffer, tricine, and 2-(N-morpholino) ethanesulfonic acid. In some embodiments, the surfactant is selected from polysorbate 20, polysorbate 40, and polysorbate 80. In some embodiments, the reducing agent is selected from thiourea and 6-aza-2-thiothymine. In some embodiments, the salt is selected from sodium chloride and sodium phosphate. In some embodiments, the radical scavenger agent selected from ascorbic acid and sodium ascorbate. In some embodiments, the chelating agent is selected from citric acid and trans-1,2-diaminocyclohexane-tetraacetic acid. In some embodiments, the protein is selected from bovine serum albumin, gelatin, and a polypeptide fraction of highly purified dermal collagen of porcine origin.

In some embodiments, the composition is in the form of a lyophilized powder, cake, or malleable film.

In some embodiments, the composition is a solution. In some embodiments, the poloxamer is present in the solution at a concentration of 0.1-20% (e.g., 0.1%, 0.2%, 0.5%, 1%, 2%, 3%, 4%, 5%, 6%, 7%, 8%, 9%, 10%, 11%, 12%, 13%, 14%, 15%, 16%, 17%, 18%, 19%, 20%, or values or ranges therebetween (e.g., 1-10%, 2.5-9%, etc.).

In some embodiments, the haloalkane-linked fluorophore is stabilized against thermal decomposition, chemical decomposition, light-induced decomposition, or any combination thereof (e.g., when compared to the same haloalkane-linked fluorophore in the absence of poloxamer)

In some embodiments, provided herein are methods of storing a compound comprising compound comprising the formula R-linker-A-X, wherein R is a small molecule fluorophore, wherein the linker is a multiatom straight or branched chain, A is (CH₂)₄₋₂₀, and X is a halide, the method comprising contacting the compound with a poloxamer. In some embodiments, contacting the compound with the poloxamer comprises dissolving the compound in an organic solvent to form a first solution, and mixing the first solution with the poloxamer to form a mixture. In some embodiments, the mixing step comprises dissolving the poloxamer in a second solution and mixing the second solution with the first solution. In some embodiments, methods further comprise contacting a solid substrate with the mixture. In some embodiments, the solid substrate is a glass, metal or plastic plate or surface. In some embodiments, the solid substrate is a paper or fiber matrix. In some embodiments, methods further comprise drying the mixture. In some embodiments, the drying step comprises lyophilization, air-drying, rotovap drying, or vacuum drying. In some embodiments, the drying is conducted at ambient temperature in an inert atmosphere. In some embodiments, the drying is conducted at a temperature of about −80° C. to about 70° C. (e.g., −80° C., −75° C., −70° C., −65° C., −60° C., −55° C., −50° C., −45° C., −40° C., −35° C., −30° C., −25° C., −20° C., −15° C., −10° C., −5° C., 0° C., 5° C., 10° C., 15° C., 20° C., 25° C., 30° C., 35° C., 40° C., 45° C., 50° C., 55° C., 60° C., 65° C., 70° C., or ranges therebetween).

### BRIEF DESCRIPTION OF THE FIGURES

FIG. 1. Graphs depicting purity over time of reconstituted lyophilized compositions comprising chloroalkyl-fluorophore compounds and poloxamer 407 polymer across varying temperatures for stability testing.

FIG. 2. Graphs and images depicting functionality testing of reconstituted lyophilized compositions comprising chloroalkyl-fluorophore compounds and poloxamer 407 polymer compared to standard solid format chloroalkyl-fluorophore compounds.

FIG. 3A-B. 100 μL DPBS reconstitution results comparison between 9-mg and 3-mg p-407 formulation of (A) 100 nmols of JF-552; left vial: 3-mg-P407 formulation with 100 μL DPBS reconstitution after 4 h, showed hazy suspension; right vial: 9-mg-P407 formulation 100 μL DPBS reconstitution after 4 h, stayed as a clear solution. (B) 100 nmols of JF-669; left vial: 3-mg-P407 formulation with 100 μL DPBS could only afford a hazy suspension; right vial: 9-mg-P407 formulation 100 μL DPBS reconstitution could afford a clear solution.

FIG. 4. Solubility of dye-chloroalkyl ligand conjugates following lyophilization in the presence of various excipients and reconstitution in DPBS pH 7.0. Graph of clarity over time of the wells containing JF552-chloroalkane or JF669-chloroalkane with excipients poloxamer, cyclodextrin, or pullulan with pullulan and cyclodextrin unable to hit clarity target due to insolubility.

FIG. 5. Solubility of dye-chloroalkyl ligand conjugates following lyophilization in the presence of poloxamer and reconstitution in DPBS pH 7.0, saline, Tris pH 8.0, bicarbonate pH 9.5, or citrate pH 6.0. Graph of clarity over time of the wells containing JF669-chloroalkanne with poloxamer reconstituted in DPBS pH 7.0, saline, Tris pH 8.0, bicarbonate pH 9.5, or citrate pH 6.0.

FIG. 6. Stability analysis of dye-chloroalkyl ligand conjugates lyophilization in the presence of various excipients after reconstitution in DPBS pH 7.0.

FIG. 7. Florescent images of fluorophore-HaloTag® ligands that have been formulated in 2.5% Poloxamer 407 with 1 nmol of ligand per vial, then lyophilized and reconstituted. The various samples excite and emit at various wavelengths across the UV/VIS spectrum. Lyophilized ligands were resuspended in 1 mL of cell media to yield a 5× working concentration of 1 uM and added to cells at final concentration of 200 nM. The top panel depicts “signal” of cells stably expressing HaloTag® and localized to the nucleus, while the bottom panel shows “background” of parental cells not expressing HaloTag® but stained with HaloTag® ligand.

### DEFINITIONS

Although any methods and materials similar or equivalent to those described herein can be used in the practice or testing of embodiments described herein, some preferred methods, compositions, devices, and materials are described herein. However, before the present materials and methods are described, it is to be understood that this invention is not limited to the particular molecules, compositions, methodologies, or protocols herein described as these may vary in accordance with routine experimentation and optimization. It is also to be understood that the terminology used in the description is for describing particular versions or embodiments only and is not intended to limit the scope of the embodiments described herein.

Unless otherwise defined, all technical and scientific terms used herein have the same meaning as commonly understood by one of ordinary skill in the art to which this invention belongs. However, in case of conflict, the present specification, including definitions, will control. Accordingly, in the context of the embodiments described herein, the following definitions apply.

The term “polymer,” as used herein, refers to an organic compound that includes two or more repeating units covalently bonded in a chain where the chain may be linear or branched. Typically, a polymer is composed of one or more repeating units that are joined together by covalent chemical bonds to form a linear backbone. The repeating units can be the same or different. Therefore, a structure of the type -A-A-A-A- wherein A is a repeating unit is a polymer, also known as a homopolymer. A structure of the type -A-B-A-B- or -A-A-A-B-A-A-A-B- wherein A and B are repeating units is also a polymer and is sometimes termed a copolymer. As used herein, the term “polymer” expressly includes chains of only two repeat units such as disaccharides and also includes chains of more repeating units such as oligosaccharides and polysaccharides. The term “polymer” also includes non-saccharide based polymers (and oligomers of as few as two monomer units) such as synthetic polymers. In some embodiments, polymers (e.g., polysaccharides) and oligomers (e.g., oligosaccharides) are limited to defined lengths (e.g., 2, 3, 4, 5, 6, 7, 8, 9, 10, 12, 14, 16, 18, 20, 25, 30, 35, 40, 45, 50, 60, 70, 80, 90, 100, 150, 200, 300, 400, 500, 750, 1000, or more, or ranges there between, e.g., 2-10, 5-25, 10-50, over 100, etc.).

As sued herein, the term “poloxamer” refers to a nonionic triblock copolymers composed of a central hydrophobic chain of polyoxypropylene (poly(propylene oxide)) flanked by two hydrophilic chains of polyoxyethylene (poly(ethylene oxide)). Poloxamers have the general structure:

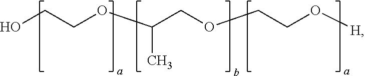

wherein a=2-130 and b=15-67. Specific poloxamers are referred to by a 3-digit number (“poloxamer 407” or “P407”); the first two digits multiplied by 100 give the approximate molecular mass of the polyoxypropylene core, and the last digit multiplied by 10 gives the percentage polyoxyethylene content (e.g., P407=poloxamer with a polyoxypropylene molecular mass of 4000 g/mol and a 70% polyoxyethylene content). oloxamers are also known by the trade names PLURONIC, KOLLIPHOR, and SYNPERONIC.

As used herein and in the appended claims, the singular forms “a,” “an,” and “the” include plural reference unless the context clearly dictates otherwise. Thus, for example, reference to “a polymer” is a reference to one or more polymers and equivalents thereof known to those skilled in the art, and so forth.

As used herein, the term “comprise” and linguistic variations thereof denote the presence of recited feature(s), element(s), method step(s), etc., without the exclusion of the presence of additional feature(s), element(s), method step(s), etc. Conversely, the term “consisting of” and linguistic variations thereof, denotes the presence of recited feature(s), element(s), method step(s), etc., and excludes any unrecited feature(s), element(s), method step(s), etc., except for ordinarily-associated impurities. The phrase “consisting essentially of” denotes the recited feature(s), element(s), method step(s), etc., and any additional feature(s), element(s), method step(s), etc., that do not materially affect the basic nature of the composition, system, or method. Many embodiments herein are described using open “comprising” language. Such embodiments encompass multiple closed “consisting of” and/or “consisting essentially of” embodiments, which may alternatively be claimed or described using such language.

As used herein, the term “small molecule” refers to a low molecular weight (e.g., <3000 daltons, <2500 daltons, <2000 daltons, <1500 daltons, <1000 daltons, <900 daltons, <800 daltons, <700 daltons, <600 daltons) compound, with dimensions (e.g., length, width, diameter, etc.) on the order of 1 nm. Larger structures, such as peptides, proteins, and nucleic acids, are not small molecules.

As used herein, the term “fluorophore” refers a fluorescent chemical moiety that can re-emit light upon light excitation (e.g., being excited by light at a first wavelength (or range of wavelengths) and emitting light at a second wavelength (or range of wavelengths). Fluorophores typically contain several combined aromatic groups, or planar or cyclic molecules with several bonds.

As used herein, the term “rhodamine” refers to a family of related dyes (xanthene derivatives), a subset of the triarylmethane dyes, having the core structure:

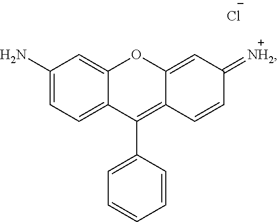

with various modifications, such as those exemplified herein.

### DETAILED DESCRIPTION

Provided herein are biotechnology reagents provided with a poloxamer excipient. In particular, haloalkane-linked fluorophores are provided in solution or a lyophilized formulation with a poloxamer that allows for storage, accurate dispensing/measurement, reconstitution, and addition to complex biological samples without the requirement of organic solvents.

In some embodiments, a composition comprising a poloxamer stabilizes the haloalkane-linked fluorophore against decomposition as compared to a composition that does not contain the poloxamer. In some embodiments, the composition enhances the reconstitution efficiency of the haloalkane-linked fluorophore. In some embodiments, the composition enhances the kinetic solubility (e.g., as compared to a composition that does not contain the poloxamer and/or the paper or fiber matrix or other surface).

In some embodiments, provided herein are compounds of formula (I):

R-linker-A-X;
wherein R is a small molecule fluorophore, A is (CH₂)₄₋₂₀. X is a halide, A-X is a substrate for a dehalogenase, and the linker is a multiatom straight or branched chain including C, N, S, or O, that optionally comprises one or more rings.

In some embodiments, R is a fluorescent small molecule moiety. In some embodiments, the fluorescent moiety is a fluorophore. Suitable fluorophores for use as fluorescent moieties herein include, but are not limited to: stilbazolium derivatives (Marquesa et al. Mechanism-Based Strategy for Optimizing HaloTag Protein Labeling. ChemRxiv. Cambridge: Cambridge Open Engage; 2021; incorporated by reference in its entirety), xanthene derivatives (e.g., fluoresceins, rhodamines, rhodols, Oregon green, cosin, Texas red, etc.), cyanine derivatives (e.g., cyanine, indocarbocyanine, oxacarbocyanine, thiacarbocyanine, merocyanine, etc.), naphthalene derivatives (e.g., dansyl and prodan derivatives), oxadiazole derivatives (e.g., pyridyloxazole, nitrobenzoxadiazole, benzoxadiazole, etc.), pyrene derivatives (e.g., cascade blue), oxazine derivatives (e.g., Nile red, Nile blue, cresyl violet, oxazine 170, etc.), acridine derivatives (e.g., proflavin, acridine orange, acridine yellow, etc.), arylmethine derivatives (e.g., auramine, crystal violet, malachite green, etc.), CF dye (Biotium), BODIPY (Invitrogen), ALEXA FLUOR (Invitrogen), DYLIGHT FLUOR (Thermo Scientific, Pierce), ATTO and TRACY (Sigma Aldrich), FluoProbes (Interchim), DY and MEGASTOKES (Dyomics), SULFO CY dyes (CYANDYE, LLC), SETAU AND SQUARE DYES (SETA BioMedicals), QUASAR and CAL FLUOR dyes (Biosearch Technologies), SURELIGHT DYES (APC, RPE, PerCP, Phycobilisomes) (Columbia Biosciences), etc.

In some embodiments, the small molecule fluorophore (R) is a rhodamine dye. In some embodiments, the thodamine dye is selected from:

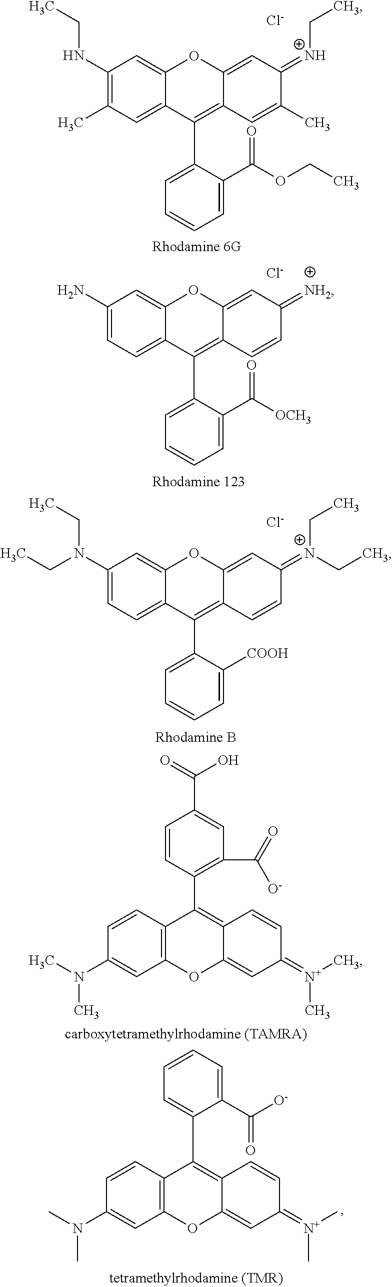

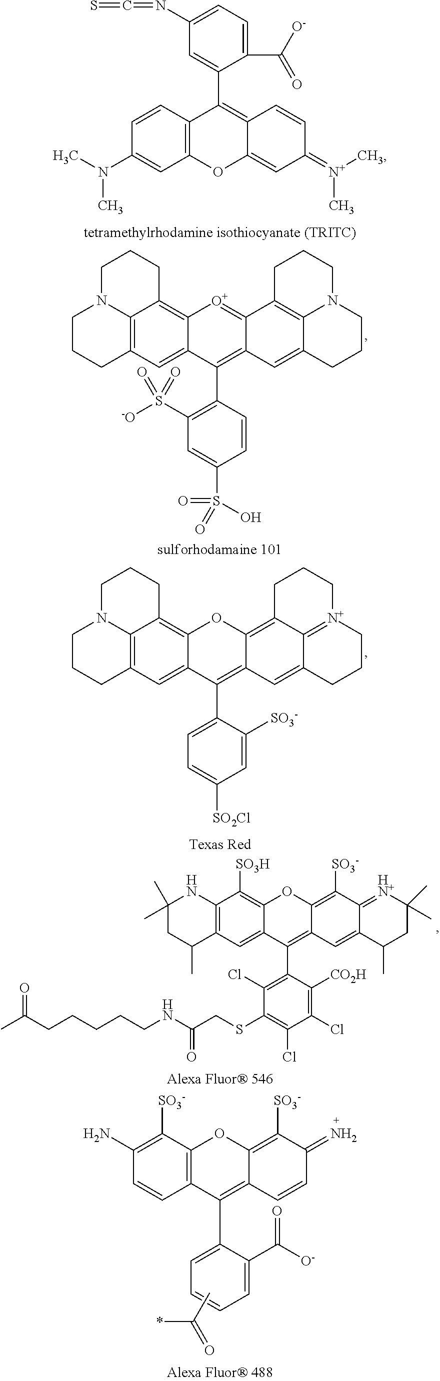

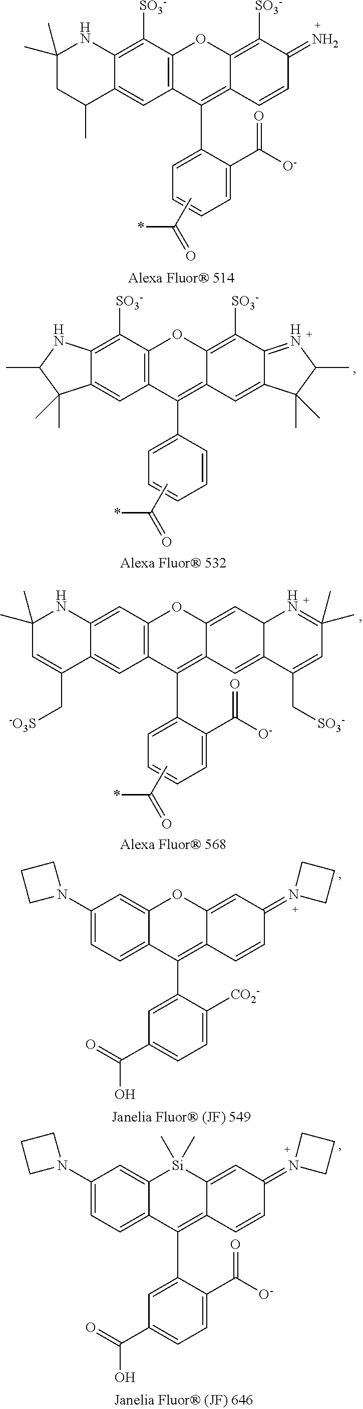

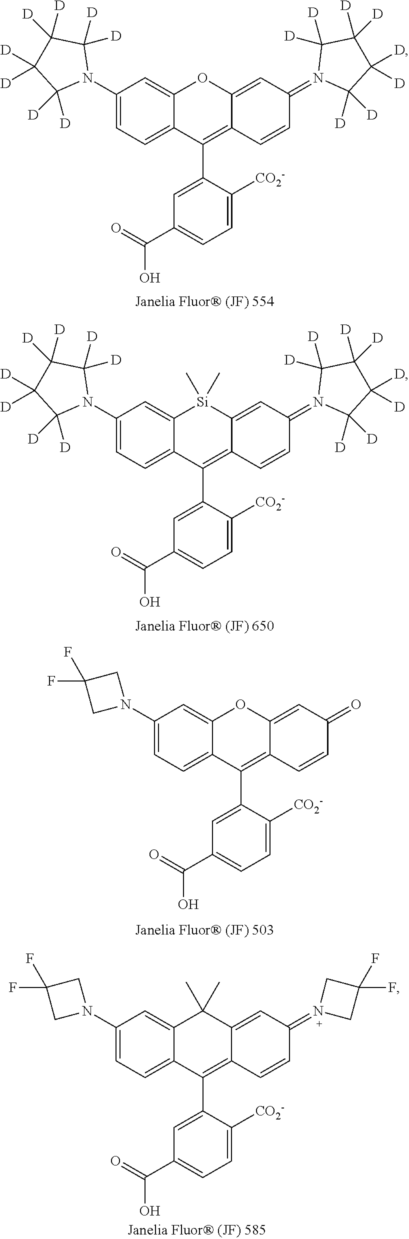

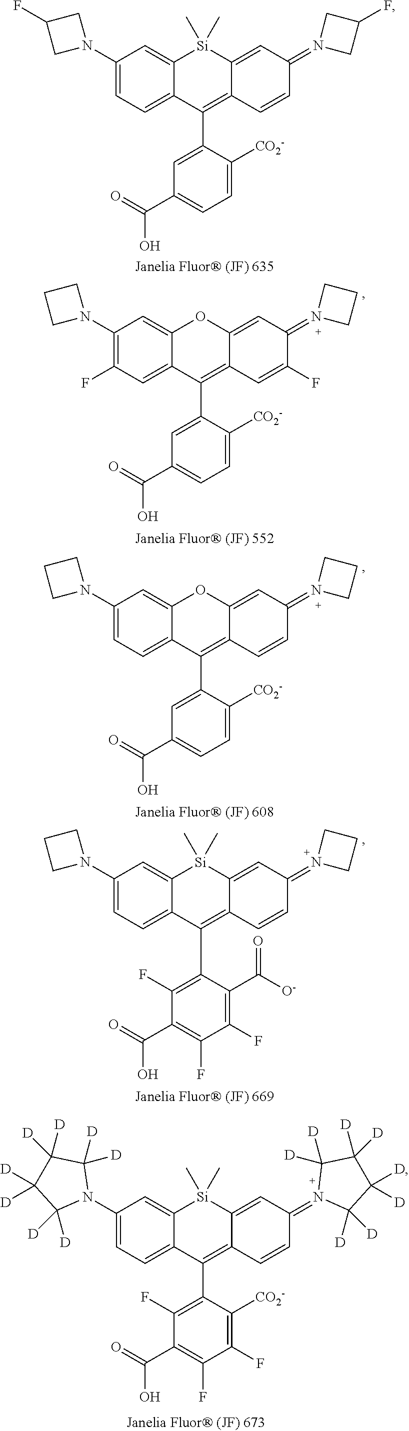

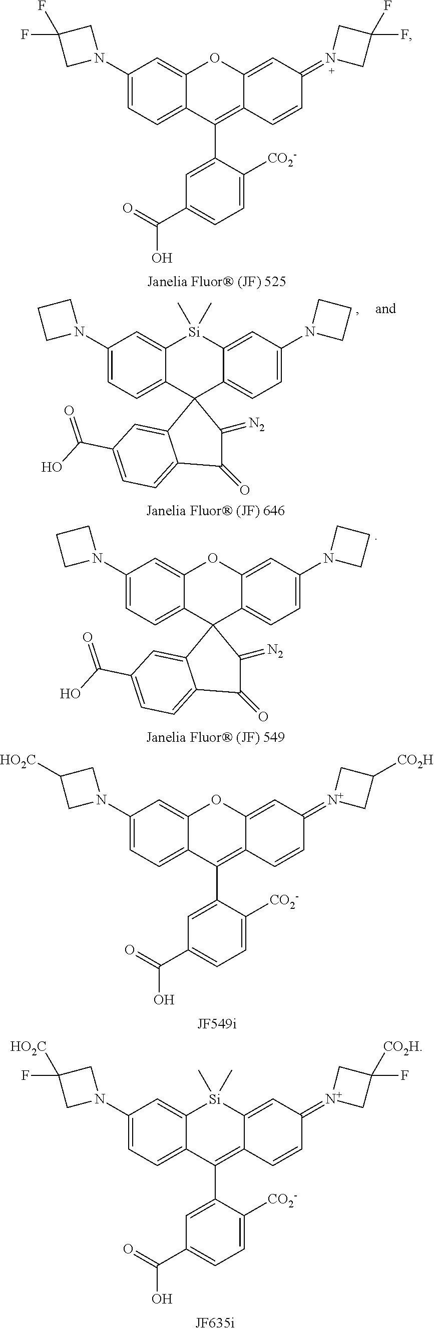

Other rhodamine and/or rhodol dyes are within the scope of embodiments herein.

In some embodiments, the fluorophore (R) is of the structure:

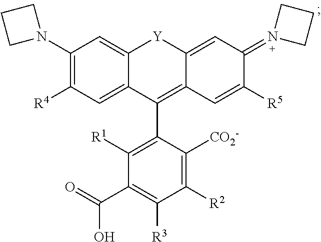

wherein Y is C, O, or Si, and wherein if Y is C or Si it is substituted with two CH₃ groups; wherein each of R¹, R², R³, R⁴, and R⁵ are independently H or F (e.g., R¹-R⁵ are all H; R¹-R⁵ are all F; R¹ and R² are F and R³ is H; R¹-R³ are F and R⁴-R⁵ are H, R¹ and R² are F and R³-R⁵ are H, etc.). In some embodiments, the azetidine are further 10 substituted with one or two nonhydrogen substituents at the 3-position (e.g., CO₂H, CH₃, F, etc.). In some embodiments, an exemplary compound herein is of the structure:

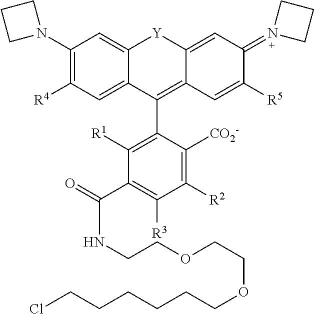

(wherein R¹⁻⁵ and Y are defined as above, Y and the azetidine are optionally substituted as above, and alternative linker and A-X groups are also within the scope).

In some embodiments, the fluorophore (R) is of the structure:

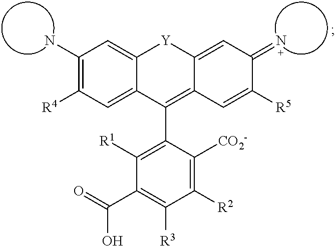

wherein Y is C, O, or Si, and wherein if Y is C or Si it is substituted with two CH₃ groups;
wherein each of R¹, R², R³, R⁴, and R⁵ are independently H or F (e.g., R¹-R⁵ are all H; R¹-R⁵ are all F; R¹ and R² are F and R³ is H; R¹-R³ are F and R⁴-R⁵ are H, R¹ and R² are F and R³-R⁵ are H, etc.); and wherein each

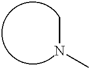

comprises an azetidine or a fully deuterated pyrrolidine. In some embodiments, the azetidine, when present are further substituted with one or two nonhydrogen substituents at the 3-position (e.g., CO₂H, CH₃, F, etc.). In some embodiments, an exemplary compound herein is of the structure:

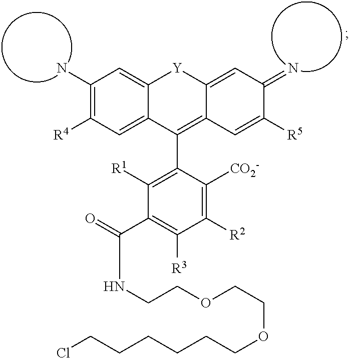

wherein R¹⁻⁵, Y, and

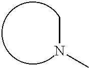

are defined as above, Y and the azetidine are optionally substituted as above, and alternative linker and A-X groups are also within the scope.

In some embodiments, the fluorophore (R) is fluorogenic moiety. A fluorogenic moiety is one that produces an enhanced fluorescent signal (e.g., 10×, 31×, 50×, 100×, 310×, 500×, 1000×, or more) upon binding of a compound comprising such a moiety to a target (e.g., binding of a haloalkane to a modified dehalogenase). Exemplary fluorogenic moieties for use in embodiments herein include the JANELIA FLUOR family of fluorophores, such as:

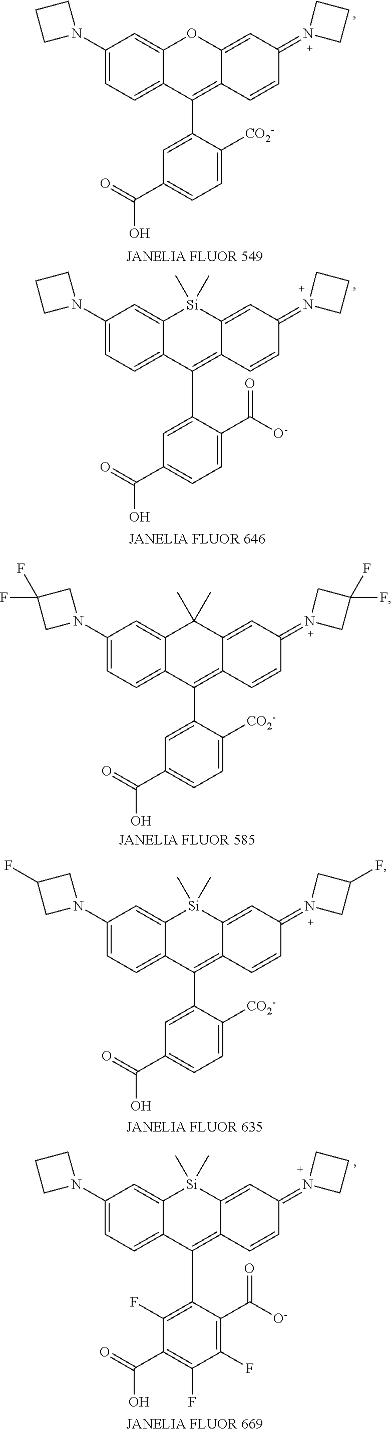

and other JANELIA FLUOR dyes described herein (see also, e.g., U.S. Pat. Nos. 9,933,417; 10,018,624; 10,161,932; and 10,495,632; each of which is incorporated by reference in their entireties). The use and design of fluorogenic functional groups, dyes, probes, and substrates is described in, for example, Grimm et al. Nat Methods. 3117 October; 14 (10): 987-994; Wang et al. Nat Chem. 3120 February; 12 (2): 165-172; incorporated by reference in their entireties.

In some embodiments, the linker is a multiatom straight or branched chain including C, N, S, or O, or a group that comprises one or more rings, e.g., saturated or unsaturated rings, such as one or more aryl rings, heteroaryl rings, or any combination thereof. In some embodiments, the linker comprises a combination of —O(CH₂)₂— —(CH₂)O—, —CH₂—, —NHC(O)O—, —OC(O)NH—, NHC(O)—, and −C(O)NH—. In some embodiments, the linker is 5 to 50 (e.g., 5, 10, 15, 20, 25, 30, 35, 40, 45, 50, or ranges therebetween) atoms in length. In some embodiments, the length of the linker for tethering the alkylhalide to the fluorophore allows for optimization of proximity and geometry (e.g., for binding of a modified dehalogenase to the alkylhalide, for function of the functional moiety (e.g., fluorescence), etc.). The scope of embodiments herein is not limited by the types of linkers available. The fluorophore and A-X may be linked either directly (e.g., linker consists of a single covalent bond) or linked via a suitable linker. Embodiments are not limited to any particular linker group. A variety of linker groups are contemplated, and suitable linkers could comprise, but are not limited to, alkyl groups, methylene carbon chains, ether, polyether, alkyl amide linker, a peptide linker, a modified peptide linker, a Poly(ethylene glycol) (PEG) linker, a streptavidin-biotin or avidin-biotin linker, polyaminoacids (e.g., polylysine), functionalized PEG, polysaccharides, glycosaminoglycans, dendritic polymers (WO93/06868 and by Tomalia et al. in Angew. Chem. Int. Ed. Engl. 29:138-175 (1990), herein incorporated by reference in their entireties), PEG-chelant polymers (W94/08629, WO94/09056 and WO96/26754, herein incorporated by reference in their entireties), oligonucleotide linker, phospholipid derivatives, alkenyl chains, alkynyl chains, disulfide, or a combination thereof. In some embodiments, the linker is cleavable (e.g., enzymatically (e.g., TEV protease site), chemically, photoinduced, etc. In some embodiments, the cleavable linker comprises an allyl-heteroatom group or a propargyl-heteroatom group, such as the linkers described, for example, in U.S. application Ser. No. 16/813,295; incorporated by reference in its entirety.

In some embodiments, A-X is a haloalkane (aka “alkyl halide”). In some embodiments, the A-X is a chloroalkane. In some embodiments, A-X is a substrate for a modified dehalogenase capable of stably binding (e.g., covalently) to a haloalkane substrate (See, e.g., U.S. Pat. Nos. 7,425,436; 7,429,472; 7,867,726; 7,888,086; 7,935,803; U.S. Pat. No. RE42,931; U.S. Pat. Nos. 8,168,405; 8,202,700; 8,257,939; herein incorporated by reference in their entireties). One such modified dehalogenase is the commercially available HALOTAG protein.

The haloalkyl compounds in the compositions and methods herein comprise a haloalkyl group, a linker, and a functional group. Exemplary compounds comprise a rhodamine dye linked to a haloalkane. Non-limiting examples of such compounds include:

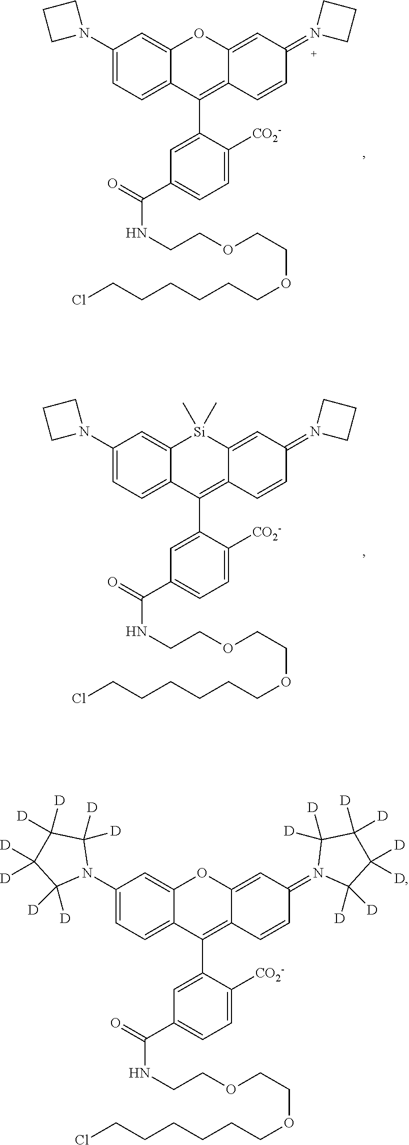

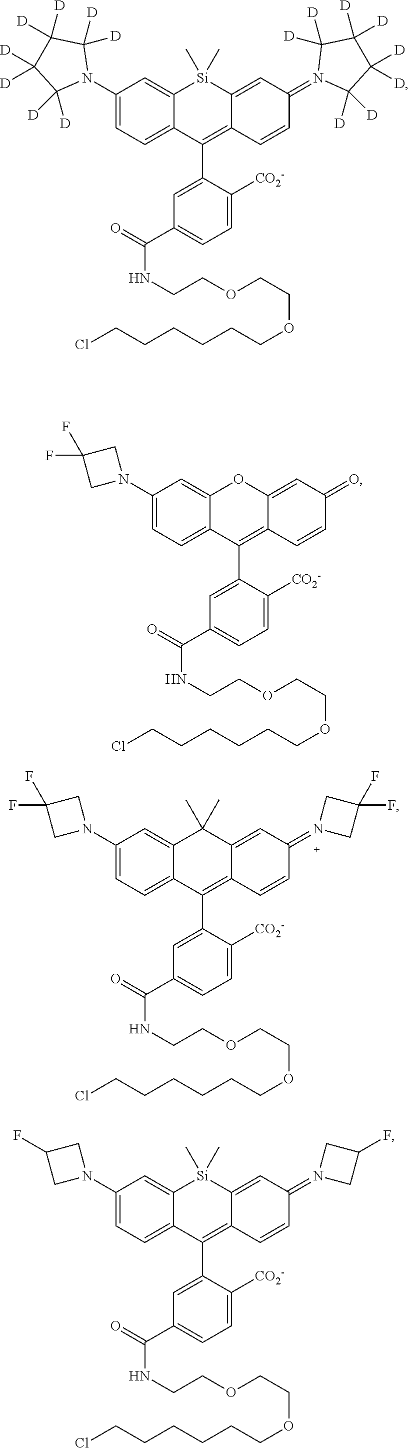

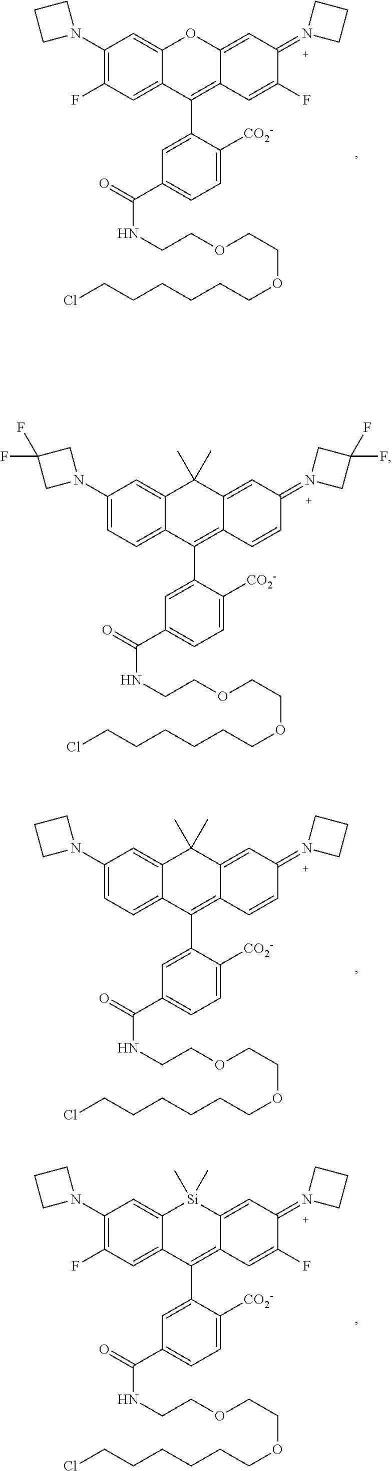

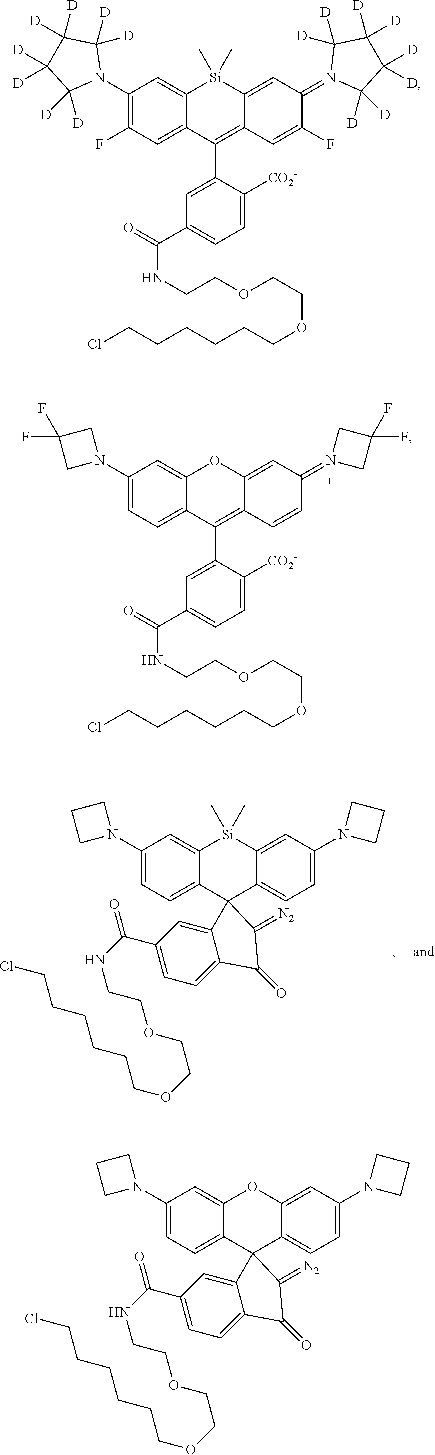

(wherein alternative linker and A-X groups are also within the scope).

In some embodiments, a fluorophore of a compound herein is a rhodamine-based dye, fluorescein-based dye, or coumarin-based dye. The fluorophores may also contain additional groups appended thereto (e.g., biotin, BAPTA, etc.). In some embodiments, a fluorophore (R) of a compound herein is a pro-fluorophore or is fluorogenic (e.g., becomes fluorescent upon binding of the ligand by HALOTAG). Non-limiting examples of fluorophores (R) within the scope herein include:

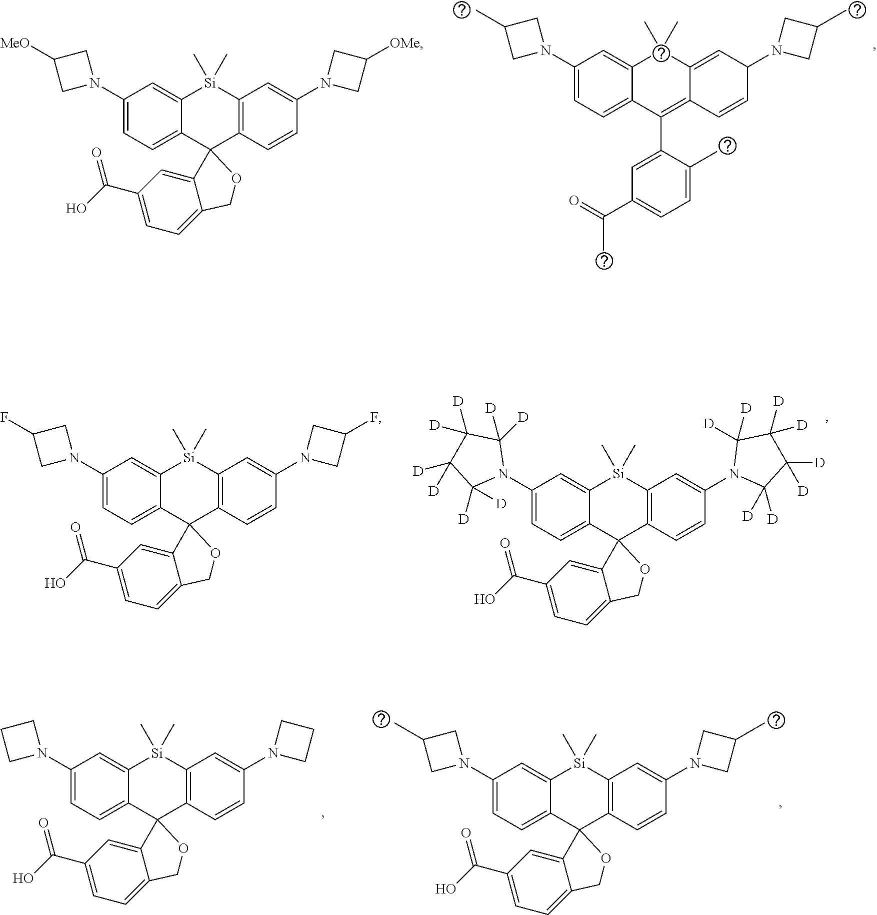

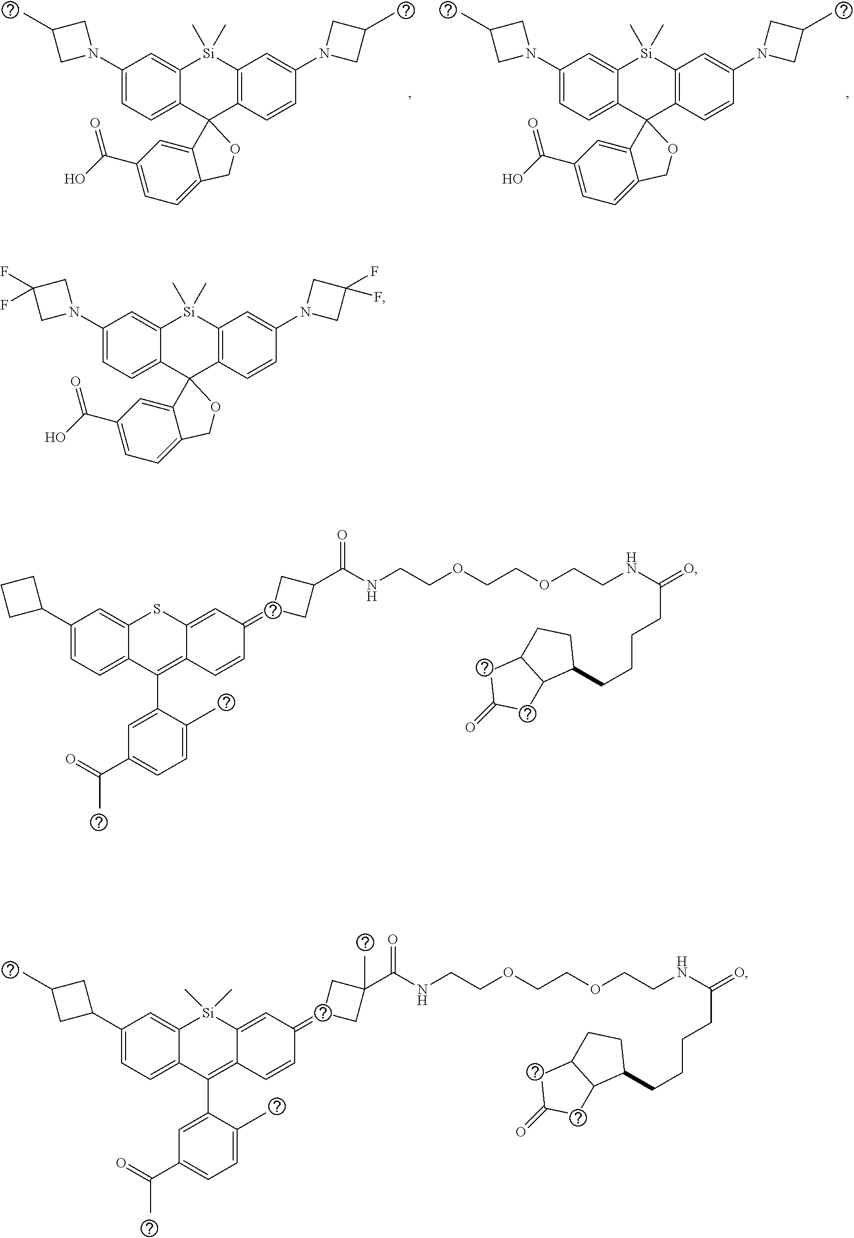

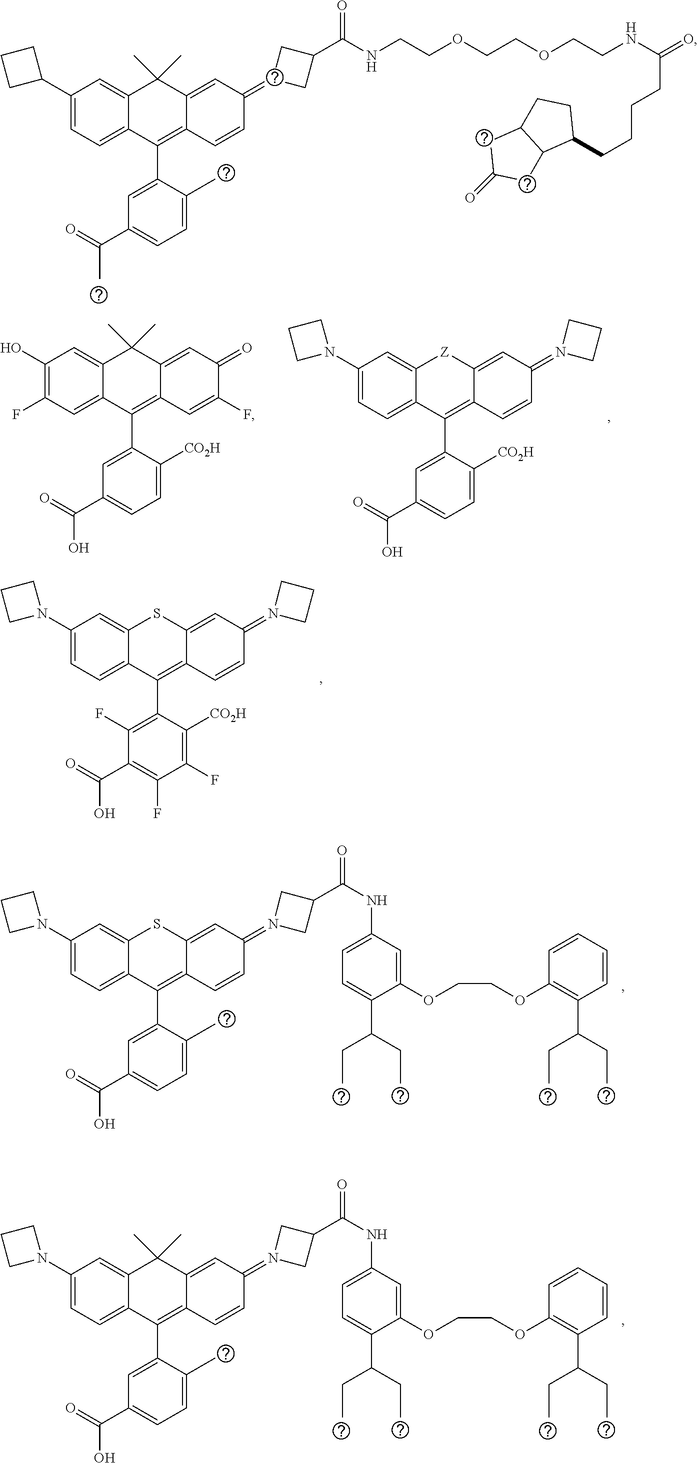

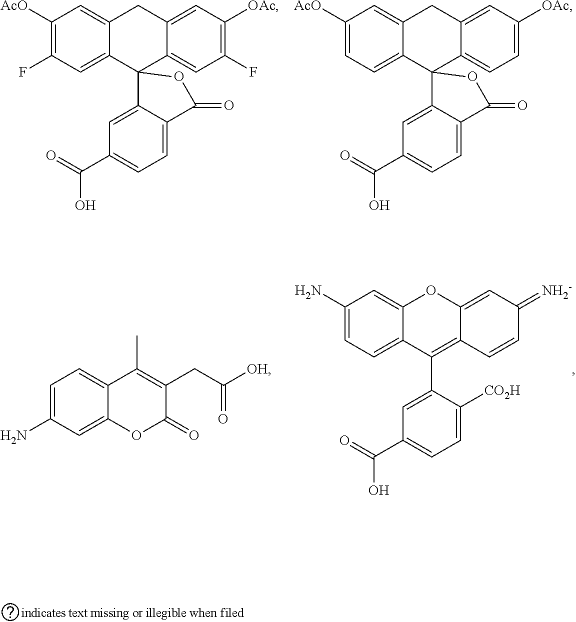 [SMILES: CC(=O)Oc1cc2c(cc1F)C1(OC(=O)c3ccc(C(=O)O)cc31)c1cc(F)c(OC(C)=O)cc1C2 ; CC(=O)Oc1ccc2c(c1)Cc1cc(OC(C)=O)ccc1C21OC(=O)c2ccc(C(=O)O)cc21 ; Cc1c(CC(=O)O)c(=O)oc2cc(N)ccc12 ; [N-]=c1ccc2c(-c3cc(C(=O)O)ccc3C(=O)O)c3ccc(N)cc3oc-2c1]

etc. Non-limiting examples of compounds comprising the above fluorophores (R) include:

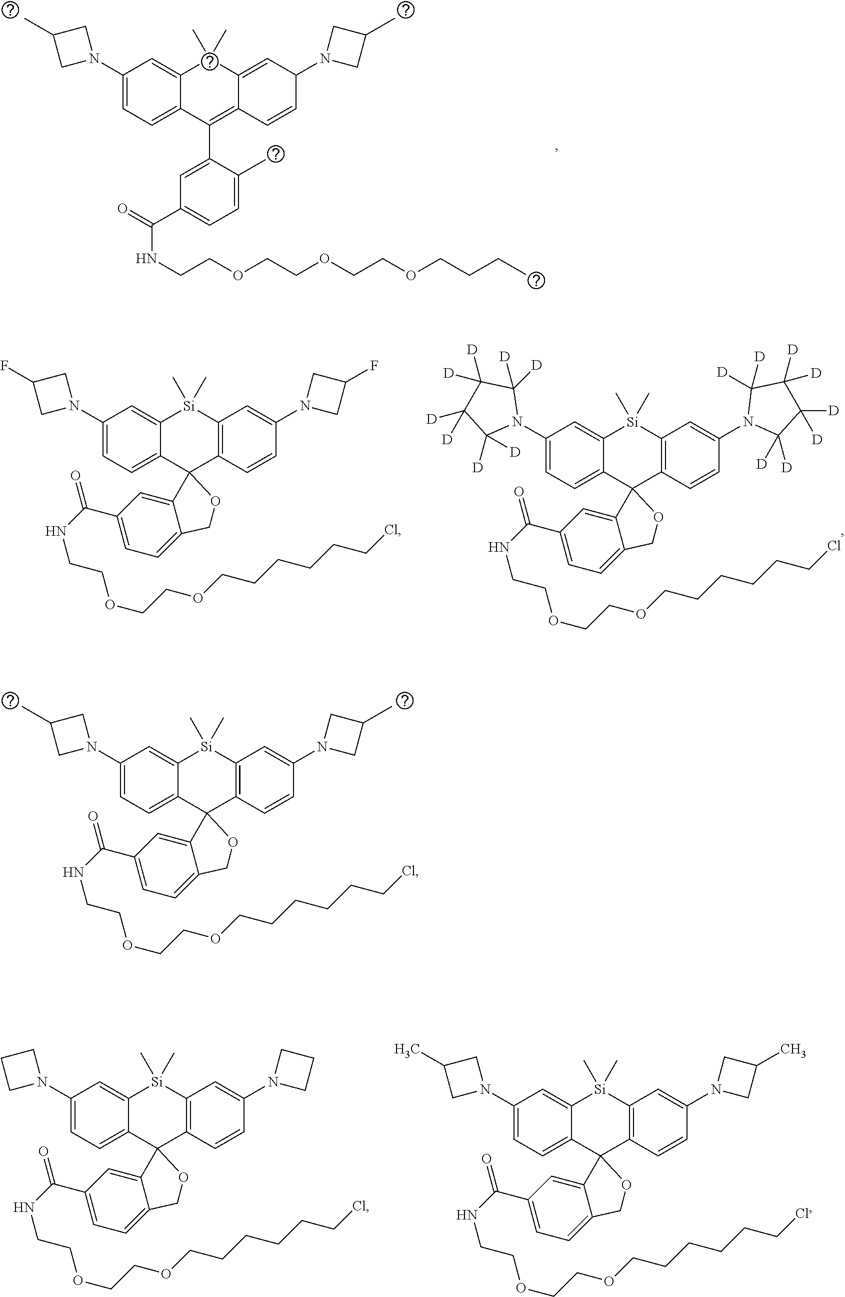

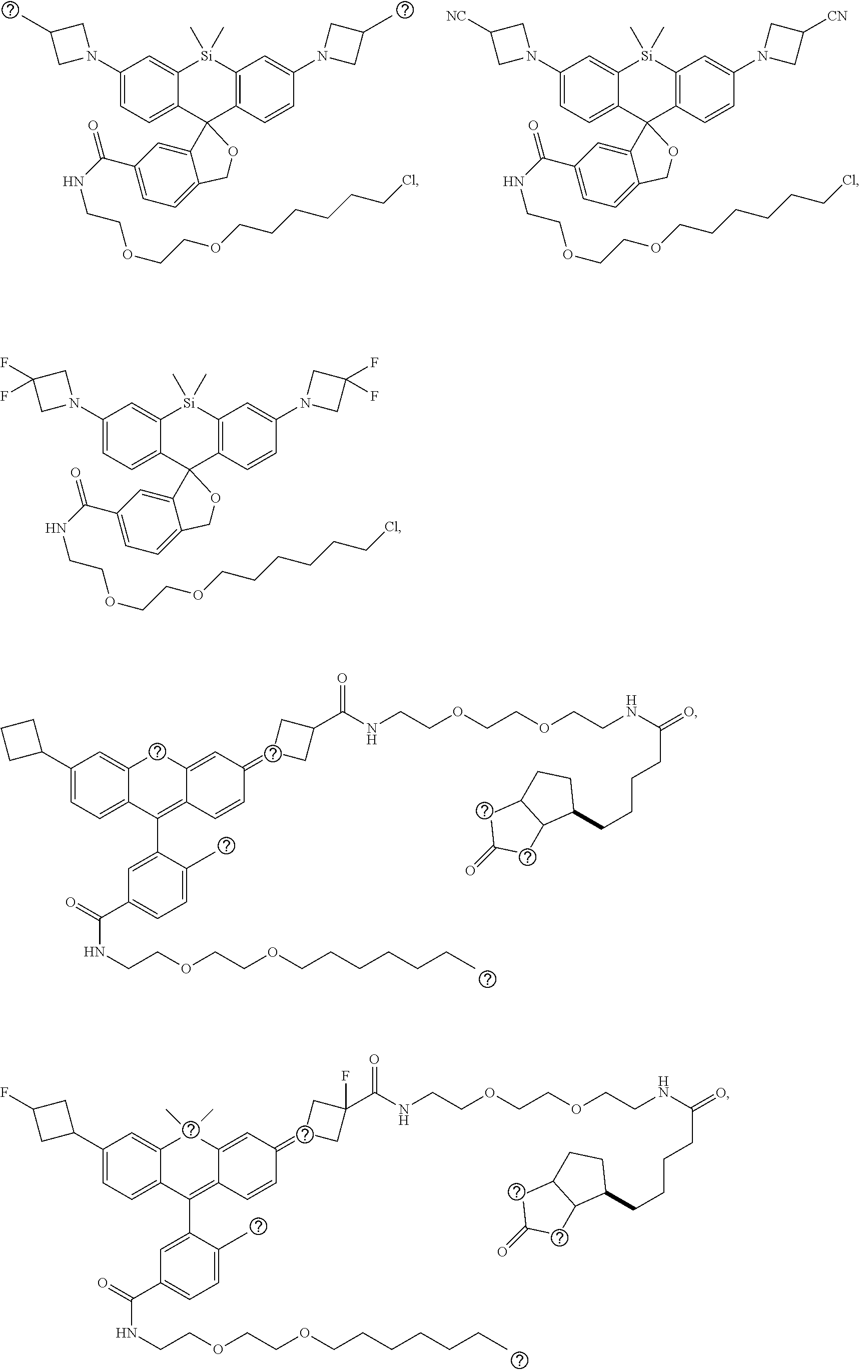

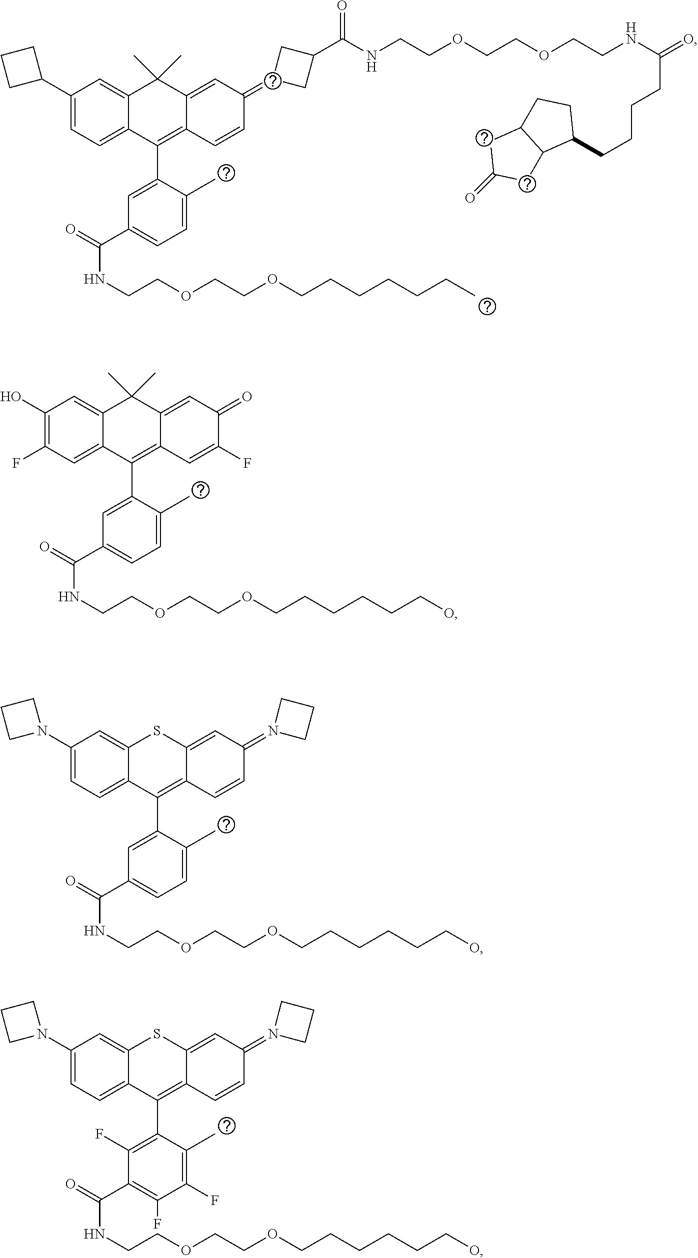

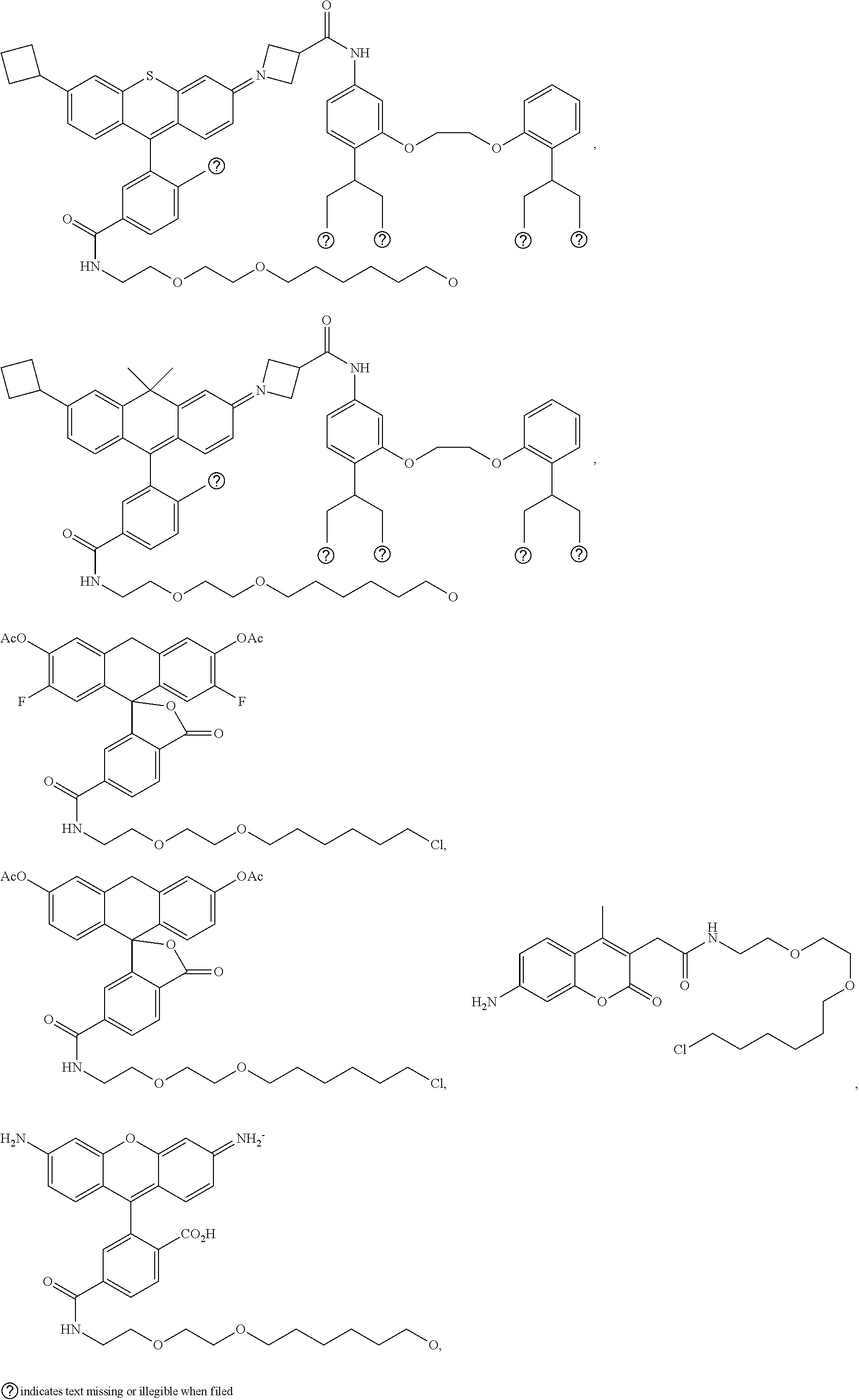

etc. (wherein alternative linker and A-X groups are also within the scope).

These exemplary compounds can be modified consistent with the disclosure herein to contain different linkers, alkyl halides, rhodamine dyes, etc.

In some embodiments, the compositions herein further comprise a poloxamer. In certain embodiments, the presence of the poloxamer stabilizes the compound against decomposition, improves the solubility of the compound in water or in aqueous solutions, etc. In some embodiments, by stabilizing the haloalkyl compound, improving the aqueous solubility of the haloalkyl compound, and/or improving the reconstitution efficiency of the haloalkyl compound in non-organic buffers, the compositions herein allow for the use of the haloalkyl compounds in point-of-care, pre-packaged, and/or solid phase systems, methods, and assays for which unformulated and/or organic-phase compounds are less suitable.

In some embodiments, the compositions herein comprise one or more poloxamers. Poloxamers are non-ionic, triblock copolymers having a central poly(propylene oxide) block flanked by two poly(ethylene oxide) blocks. Poloxamers are also known by certain trade names, including Pluronic® and Kolliphor®. Exemplary poloxamers include poloxamer 101, poloxamer 105, poloxamer 108, poloxamer 122, poloxamer 123, poloxamer 124, poloxamer 181, poloxamer 182, poloxamer 183, poloxamer 184, poloxamer 185, poloxamer 188, poloxamer 212, poloxamer 215, poloxamer 217, poloxamer 231, poloxamer 234, poloxamer 235, poloxamer 237, poloxamer 238, poloxamer 282, poloxamer 284, poloxamer 288, poloxamer 331, poloxamer 333, poloxamer 334, poloxamer 335, poloxamer 338, poloxamer 401, poloxamer 402, poloxamer 403, and poloxamer 407. In some embodiments, liquid compositions herein comprise a poloxamer at a concentration of 0.1% to 20% (e.g., 0.1%, 0.2%, 0.5%, 1%, 2%, 3%, 4%, 5%, 6%, 7%, 8%, 9%, 10%, 11%, 12%, 13%, 14%, 15%, 16%, 17%, 18%, 19%, 20%, or values or ranges therebetween (e.g., 1-10%, 2.5-9%, etc.).

In addition to a haloalkane-linked fluorophore and a poloxamer, compositions herein may also include an additional polymer or excipient component.

The additional polymer may be a naturally-occurring biopolymer or a synthetic polymer. In some embodiments, the polymer is a naturally-occurring biopolymer. Suitable naturally-occurring biopolymers are carbohydrates, including disaccharides (e.g., trehalose, maltose, and sucrose), polysaccharides (e.g., pullulan, dextran, and cellulose), and non-sulfated glycosaminoglycans (e.g., hyaluronic acid). Mixtures of naturally-occurring biopolymers may also be used. The polymer may be a derivative of a naturally-occurring polymer, such as a functionalized cellulose (e.g., hydroxypropyl cellulose, hydroxypropyl methylcellulose, or the like).

In some embodiments, the additional polymer is pullulan, which is a polysaccharide that includes maltotriose-repeating units. Maltotriose is a trisaccharide that includes three glucose units that are linked via α-1,4 glycosidic bonds. The maltotriose units within the pullulan polymer are linked to each other via α-1,6 glycosidic bonds. Pullulan is naturally produced from starch by the fungus Aureobasidum pullulans, and generally has a mass range of about 4.5×10⁴ to about 6×10⁵ Da, and is commercially available from a variety of suppliers (CAS No. 9057-02-7).

In some embodiments, the additional polymer is dextran, which is a complex branched polysaccharide that includes glucose repeating units. Straight chains linkages are generally formed by α-1,6 glycosidic bonds while branches typically begin from α-1,3 linkages. Naturally-occurring dextran can have a molecular weight ranging from about 9 kDa to about 2000 kDa. Dextran can be synthesized from sucrose by certain bacteria including Leuconostoc mesenteroides and Streptococcus mutans. Commercially available dextran (CAS No. 9004-54-0) produced by Leuconostoc mesenteroides can be purchased from a variety of suppliers including Sigma Aldrich, and may have a variety of molecular weight ranges ranging from about 1 kDa to about 670 kDa.

In some embodiments, the additional polymer is a cyclic saccharide polymer such as a cyclodextrin. Typical cyclodextrins are α-cyclodextrins, β-cyclodextrins, and γ-cyclodextrins, which have six, seven, and eight glucopyranose units, respectively. The glucopyranose units can be functionalized. An exemplary cyclodextrin is hydroxypropyl-β-cyclodextrin.

In some embodiments, the additional polymer is a non-sulfated glycosaminoglycan. Glycosaminoglycans are linear polysaccharides having repeating disaccharide units, each repeating unit including one amino sugar (N-acetylglucosamine or N-acetylgalactosamine) and either an uronic sugar (glucuronic acid or iduronic acid) or galactose. An exemplary non-sulfated glycosaminoglycan is hyaluronic acid in which the repeating disaccharides include N-acetylglucosamine and glucuronic acid linked via alternating β-(1→4) and β-(1→3)glycosidic bonds. Polymers of hyaluronic acid can range in size from κ to 20000 kDa.

In some embodiments, the additional polymer is cellulose, which is a polysaccharide of linear, repeating β-1,4 linked D-glucose units. Natural fibers can exist with up to 10,000 glucose units, with molecular weights of greater than 1000 Da.

In some embodiments, the additional polymer is a synthetic polymer. A synthetic polymer may be a homopolymer, copolymer, block copolymer (e.g., diblock copolymer, triblock copolymer, etc.). Non-limiting examples of suitable polymers include, but are not limited to, polyamines, polyethers, polyamides, polyesters, polycarbamates, polyureas, polycarbonates, polystyrenes, polyimides, polysulfones, polyurethanes, polyacetylenes, polyethylenes, polyethyencimines, polyisocyanates, polyacrylates, polymethacrylates, polyacrylonitriles, and polyarylates. Non-limiting examples of specific polymers include poly(caprolactone) (PCL), ethylene vinyl acetate polymer (EVA), poly(lactic acid) (PLA), poly(L-lactic acid) (PLLA), poly(glycolic acid) (PGA), poly(lactic acid-co-glycolic acid) (PLGA), poly(L-lactic acid-co-glycolic acid) (PLLGA), poly(D,L-lactide) (PDLA), poly(L-lactide) (PLLA), poly(D,L-lactide-co-caprolactone), poly(D,L-lactide-co-caprolactone-co-glycolide), poly(D,L-lactide-co-PEO-co-D,L-lactide), poly(D,L-lactide-co-PPO-co-D,L-lactide), polyalkyl cyanoacrylate, polyurethane, poly-L-lysine (PLL), hydroxypropyl methacrylate (HPMA), poly(ethylene glycol), poly-L-glutamic acid, poly(hydroxy acids), polyanhydrides, polyorthoesters, poly(ester amides), polyamides, poly(ester ethers), polycarbonates, polyalkylenes (e.g., polyethylene and polypropylene), polyalkylene glycols (e.g., poly(ethylene glycol) (PEG) and poly(propylene glycol) (PPG)) and copolymers thereof (e.g., poloxamers), polyalkylene terephthalates (e.g., poly(ethylene terephthalate), etc.), polyvinyl alcohols (PVA), polyvinyl ethers, polyvinyl esters (e.g., poly(vinyl acetate), etc.), polyvinyl halides (e.g., poly(vinyl chloride) (PVC), etc.), polyvinylpyrrolidone, polysiloxanes, polystyrene (PS), polyurethanes, derivatized celluloses (e.g., alkyl celluloses, hydroxyalkyl celluloses, cellulose ethers, cellulose esters, nitro celluloses, hydroxypropylcellulose, carboxymethylcellulose, etc.), polymers of acrylic acids (“polyacrylic acids”) (e.g., poly(methyl(meth)acrylate) (PMMA), poly(ethyl(meth)acrylate), poly(butyl(meth)acrylate), poly(isobutyl(meth)acrylate), poly(hexyl(meth)acrylate), poly(isodecyl(meth)acrylate), poly(lauryl (meth)acrylate), poly(phenyl (meth)acrylate), poly(methyl acrylate), poly(isopropyl acrylate), poly(isobutyl acrylate), poly(octadecyl acrylate), polydioxanone and its copolymers (e.g., polyhydroxyalkanoates, polypropylene fumarate), polyoxymethylene, poly(ortho) esters, poly(butyric acid), poly(valeric acid), poly(lactide-co-caprolactone), trimethylene carbonate, polyvinylpyrrolidone (PVP), poly(l-vinylpyrrolidone-co-vinyl acetate) (PVP-VA), poly(4-vinylpyridine), poly(4-vinylpyridine-co-butyl methacrylate), poly(4-vinylpyridine-co-styrene), poly[4-vinylpyridinium poly(hydrogen fluoride), methylacrylate (p(MAA-co-MMA)) copolymers, poly(1-vinylpyrrolidone-co-2-dimethylaminoethyl methacrylate), poly(l-vinylpyrrolidone-co-styrene), poly(4-vinylpyridinium p-toluenesulfonate), hydroxypropyl acetate succinate (HPMC), hydroxypropyl methylcellulose acetate succinate (HPMCAS), poly(ethylene-alt-propylene) (PEP), 2-methyl acrylamido glucopyranose (MAG), dimethyl adipimidate (DMA), polyvinyl caprolactam-polyvinyl acetate, and mixtures and copolymers of any thereof.

In some embodiments, the additional synthetic polymer is a polyalkylene glycol. In some embodiments, the synthetic polymer is a polyalkylene glycol copolymer. In some embodiments, the synthetic polymer is a block copolymer comprising at least one poly(propylene oxide) block and at least one poly(ethylene oxide) block, such as an additional poloxamer.

In some embodiments, the compound (i.e., haloalkyl compound (e.g., R-linker-A-X) and the poloxamer may be present in the composition in a weight ratio of about 0.000001:1 to about 1:1 (e.g., 0.000001:1, 0.000002:1, 0.000005:1, 0.00001:1, 0.00002:1, 0.00005:1, 0.0001:1, 0.0002:1, 0.0005:1, 0.001:1, 0.002:1, 0.005:1, 0.01:1, 0.02:1, 0.05:1, 0.1:1, 0.2:1, 0.5:1, 1:1, or ranges therebetween).

In some embodiments, compositions include a buffer such as a phosphate buffer, a borate buffer, an acetate buffer, or a citrate buffer, or other common buffers such as bicine, tricine, tris(hydroxymethyl)aminomethane (tris), N-[tris(hydroxymethyl)methyl]-3-aminopropanesulfonic acid (TAPS), 3-[N-tris(hydroxymethyl)methylamino]-2-hydroxypropanesulfonic acid (TAPSO), 2-[4-(2-hydroxyethyl) piperazin-1-yl]ethanesulfonic acid (HEPES), N-[tris(hydroxymethyl) methyl]-2-aminoethanesulfonic acid (TES), piperazine-N,N′-bis(2-ethanesulfonic acid) (PIPES), 2-(N-morpholino) ethanesulfonic acid (MES), Dulbecco's phosphate buffered saline (DPBS), carbonate buffers (e.g., sodium carbonate and sodium bicarbonate solutions), citrate buffer, or the like. In some embodiments, the composition includes a phosphate buffer. In some embodiments, the composition includes tricine. In some embodiments, the composition includes 2-(N-morpholino) ethanesulfonic acid. Compositions can also include any combination of buffers. In some embodiments, a dried composition herein is reconstituted in a solution comprising a buffer (e.g., at a desired pH (e.g., 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, or more, or less).

In some embodiments, the composition further comprises (e.g., in addition to a haloalkane-linked fluorophore and poloxamer) a detergent or surfactant. In some embodiments, a detergent or surfactant is present at about 0.01 mol % to 5 mol % (e.g., 0.01%, 0.02%, 0.05%, 0.1%, 0.2%, 0.5%, 1%, 2%, 5%, 10%, or any ranges therebetween (e.g., 0.1 to 0.5%). Exemplary surfactants include non-ionic surfactants, anionic surfactants, cationic surfactants, and zwitterionic surfactants. Examples of nonionic detergents include Brij 35, Triton™ surfactants, such as the Triton™ X series (octylphenol ethoxylates such as Triton™ X-100, Triton™ X-100R, Triton™ X-114, etc.), octyl glucoside, polyoxyethylene (9) dodecyl ether, digitonin, octylphenyl polyethylene glycol (IGEPAL CA630), n-octyl-beta-D-glucopyranoside (betaOG), n-dodecyl-beta-D-maltoside, Tween® 20 (polysorbate 20 or polyethylene glycol (20) sorbitan monolaurate), Tween® 40 (polysorbate 40 or polyethylene glycol (20) sorbitan monopalmitate), Tween® 80 (polysorbate 80 or polyethylene glycol (20) sorbitan monooleate), polidocanol, n-dodecyl beta-D-maltoside (DDM), Nonidet P40-substitute, NP-40 nonylphenyl polyethylene glycol, C12E8 (octaethylene glycol n-dodecyl monoether), hexaethyleneglycol mono-n-tetradecyl ether (C14E06), octyl-beta-thioglucopyranoside (octyl thioglucoside, OTG), Pluronic® F-68 (poloxamer 188), Pluronic® F-127 (poloxamer 407), saponin, Emulgen, polyethylene glycol trimethylnonyl ether, and polyoxyethylene 10 lauryl ether (C12E10). Examples of ionic detergents (anionic or cationic) include deoxycholate, sodium cholate, sodium dodecyl sulfate (SDS), N-lauroylsarcosine, and cetyltrimethylammoniumbromide (CTAB). Examples of zwitterionic reagents include Chaps, zwitterion 3-14, and 3-[(3-cholamidopropyl)dimethylammonio]-1-propanesulfonate. In some embodiments, the surfactant is polysorbate 20. Compositions can also include any combination of surfactants.

In some embodiments, the composition may further include (e.g., in addition to a haloalkane-linked fluorophore and poloxamer) a reducing agent such as dithiothreitol (DTT), 2-mercaptoethanol (BME), cysteamine, (2S)-2-amino-1,4-dimercaptobutane (DTBA), thiourea, 6-aza-2-thiothymine (ATT), or the like. In some embodiments, the reducing agent is thiourea. In some embodiments, the reducing agent is ATT. Compositions can also include any combination of reducing agents.

In some embodiments, the composition may further include (e.g., in addition to a haloalkane-linked fluorophore and poloxamer) a salt such as sodium chloride, potassium chloride, magnesium chloride, sodium phosphate, or the like. In some embodiments, the salt is sodium chloride. In some embodiments, the salt is sodium phosphate. Compositions can also include any combination of salts.

In some embodiments, the composition may further include (e.g., in addition to a haloalkane-linked fluorophore and poloxamer) radical scavengers such as ascorbic acid, sodium ascorbate, or the like. In some embodiments, the composition may include a metal chelator such as citric acid, ethylenediamine tetraacetic acid, trans-1,2-diaminocyclohexane-tetraacetic acid, or the like. In some embodiments, the composition includes ascorbic acid. In some embodiments, the composition includes sodium ascorbate. In some embodiments, the composition includes citric acid. In some embodiments, the composition includes trans-1,2-diaminocyclohexane-tetraacetic acid. Compositions can include any combination of radical scavengers and/or chelators.

In some embodiments, the composition may further include (e.g., in addition to a haloalkane-linked fluorophore and poloxamer) a protein. For example, the composition can include a carrier protein. In some embodiments, the protein may be bovine serum albumin (BSA). In some embodiments, the protein may be a polypeptide fraction of highly purified dermal collagen of porcine origin (e.g., Prionex). In some embodiments, the protein may be gelatin. Compositions can also include any combination of proteins.

In some embodiments, the composition may further include (e.g., in addition to a haloalkane-linked fluorophore and poloxamer) a solvent. Some compositions are fully dried such that any solvents may be removed, while other compositions may include solvents or some amount of residual solvents. In some embodiments, the composition may include an organic solvent, such as methanol, ethanol, iso-propanol, ethylene glycol, propylene glycol, or the like, or any combination thereof. For example, the composition may include a combination of ethanol and propylene glycol.

As described above, the composition can include any combination of the above-described components (e.g., in addition to a haloalkane-linked fluorophore and poloxamer). For example, in some embodiments the composition can include a protein, a buffer, and a reducing agent. In some embodiments the composition can include a protein, a buffer, and a metal chelator.

The compositions herein may be in the form of a lyophilized powder or cake. Such a composition can be prepared by freeze-drying a mixture of the components of the composition as further described below. The powdered product may be provided in a container such as a bottle, a vial, a snap tube, microtiter plate, on a paper or fiber matrix or other solid material support, in a lab-on-chip, or the like. The powdered product may be included in a plurality of snap tubes with each tube containing a pre-determined amount of the composition that be dissolved into an appropriate amount of a solution and directly used in an assay of interest.

The composition may also be in the form of a hard but malleable material such as a “drop” cast or a film. Such a composition can be prepared by applying a solution containing the components of the composition (e.g., a haloalkane-linked fluorophore and poloxamer) to a surface and drying the composition, e.g., by air-drying, drying at ambient temperature, drying at an elevated temperature (e.g., at a temperature of about 30° C. to about 70° C., or about 30° C. to about 40° C., for example at about 30° C., about 35° C., about 40° C., about 45° C., about 50° C., about 55° C., about 60° C., about 65° C., or about 70° C.), drying under an inert atmosphere, or by drying under vacuum. The drop cast or film may be provided in a container, such as a bottle, a vial, a snap tube, a microtiter plate, microtiter plate, on a paper or fiber matrix or other solid material support, in a lab-on-chip, or the like.

In some embodiments, the composition is in the form of a solution (e.g., an aqueous solution). When the composition is a solution, the composition may have a pH of about 5.5 to about 8.0, e.g., about 6.5 to about 7.5. In some embodiments, the composition has a pH of about 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 77.3, 7.4, 7.5, 7.6, 7.7, 7.8, 7.9, or 8.0.

The composition may also be provided in other forms such as tablets or capsules including dissolvable tablets or capsules that can be dropped into a sample such as a buffer or a biological sample. The compositions could also be included as pre-formed films on surfaces such as the wells of 96-well plates, such that the compositions can be dissolved straight into an appropriate amount of a solution, and used directly in an assay of interest.

The compositions of the disclosure may be used in any way that haloalkyl compounds (e.g., HALOTAG ligands), have been used. For example, they may be used in a method that employs HALOTAG, to detect or isolate one or more molecules in a sample, e.g., an enzyme, a cofactor for an enzymatic reaction, an enzyme substrate, an enzyme inhibitor, an enzyme activator, etc. The sample may include an animal (e.g., a vertebrate), a plant, a fungus, physiological fluid (e.g., blood, plasma, urine, mucous secretions), a cell, a cell lysate, a cell supernatant, or a purified fraction of a cell (e.g., a subcellular fraction).

Provided herein are methods of stabilizing a haloalkyl-linked fluorophore comprising contacting the compound with an effective amount of a poloxamer and/or a paper or fiber matrix to form a composition. The haloalkyl-linked fluorophore may be stabilized against thermal decomposition, chemical decomposition, light-induced decomposition, or any combination thereof.

In some embodiments, compositions herein stabilize the haloalkyl-linked fluorophore against decomposition at temperatures from about −80° C. to about 80° C., about −75° C. to about 80° C., about −70° C. to about 80° C., about −65° C. to about 80° C., about −60° C. to about 80° C., about-55° C. to about 80° C., about-50° C. to about 80° C., about −45° C. to about 80° C., about −40° C. to about 80° C., about −35° C. to about 80° C., about-30° C. to about 80° C., about −25° C. to about 80° C., about-20° C. to about 80° C., about −15° C. to about 80° C., about −10° C. to about 80° C., about −5° C. to about 80° C., about 0° C. to about 80° C., about −80° C. to about 75° C., about −80° C. to about 70° C., about −80° C. to about 65° C., about −80° C. to about 60° C., about −80° C. to about 55° C., about −80° C. to about 50° C., about −80° C. to about 45° C., about −80° C. to about 40° C., about −80° C. to about 35° C., about −80° C. to about 30° C., about −80° C. to about 25° C., about −20° C. to about 60° C., about-20° C. to about 55° C., about-20 to about 50° C., about-20° C. to about 45° C., about −20° C. to about 40° C., about −20° C. to about 35° C., about −20° C. to about 30° C., or about −20° C. to about 25° C.

In some embodiments, compositions herein stabilize the haloalkyl-linked fluorophore against decomposition for at least about 1 day, 2 days, 3 days, 4 days, 5 days, 6 days, 7 days, 8 days, 9 days, 10 days, 11 days, 12 days, 13 days, 14 days, 15 days, 16 days, 17 days, 18 days, 19 days, 20 days, 21 days, 22 days, 23 days, 24 days, 25 days, 26 days, 27 days, 28 days, 29 days, 30 days, 35 days, 40 days, 45 days, 50 days, 55 days, 60 days, 65 days, 70 days, 75 days, 80 days, 85 days, 90 days, 100 days, 110 days, 120 days, 130 days, 140 days, 150 days, 160 days, 170 days, 180 days, 190 days, 200 days, 210 days, 220 days, 230 days, 240 days, 250 days, 260 days, 270 days, 280 days, 290 days, 300 days, 310 days, 320 days, 330 days, 340 days, 350 days, 360 days, 1 year, 2 years, 3 years, 4 years, or 5 years, as compared to the composition that does not contain the polymer or the paper or fiber matrix.

In some embodiments, compositions increase the half-life of the haloalkyl-linked fluorophore against decomposition by at least about 1.25-fold, 1.5-fold, 1.75-fold, 2-fold, 3-fold, 4-fold, 5-fold, 6-fold, 7-fold, 8-fold, 9-fold, 10-fold, 11-fold, 12-fold, 13-fold, 14-fold, 15-fold, 16-fold, 17-fold, 18-fold, 19-fold, 20-fold, 21-fold, 22-fold, 23-fold, 24-fold, or 25-fold as compared to the composition that does not include the polymer or the paper or fiber matrix. Also provided herein is a method of improving the solubility of a haloalkyl-linked fluorophore herein comprising contacting the haloalkyl-linked fluorophore with an effective amount of a poloxamer and/or a paper or fiber matrix wherein the solubility of the haloalkyl-linked fluorophore is improved compared to a haloalkyl-linked fluorophore that has not been contacted with the poloxamer. The solubility of the haloalkyl-linked fluorophore may be improved in an aqueous solution compared to a corresponding haloalkyl-linked fluorophore that has not been contacted with the poloxamer and/or the paper or fiber matrix. The solubility of the haloalkyl-linked fluorophore may be improved when in the presence of the poloxamer after reconstitution of the lyophilized powder, drop case film or “droplet,” or from rehydration of the paper or fiber matrix or other solid support material to which the haloalkyl-linked fluorophore has been placed onto or into.

In some embodiments, the composition increases the solubility of the haloalkyl-linked fluorophore in, e.g., pure water or in aqueous solutions such as those that further include a buffer, a salt, a protein, a reducing agent, a radical scavenger, a surfactant, or the like, or any combination of such components. In some embodiments, the composition increases the solubility of the haloalkyl-linked fluorophore in, e.g., an aqueous buffer such as phosphate-buffered saline (PBS) at a pH of about 6.5 to about 7.5 (e.g., at a pH of about 6.5, 6.6, 6.7, 6.8, 6.9, 7.0, 7.1, 7.2, 7.3, 7.4, or 7.5, or any range therebetween) or in another suitable buffer. In some embodiments, the composition increases the solubility of the haloalkyl-linked fluorophore in, e.g., biological or environmental fluids such as a biological sample from a subject, culture media (e.g., cell culture media), or the like.

Also provided herein are methods of improving the reconstitution rate of a haloalkyl-linked fluorophore herein, comprising contacting the haloalkyl-linked fluorophore with an effective amount of poloxamer and/or a paper or fiber matrix, wherein the reconstitution rate for the haloalkyl-linked fluorophore is improved compared to a haloalkyl-linked fluorophore that has not been contacted with the poloxamer and/or the paper or fiber matrix.

n some embodiments, the composition increases the reconstitution rate of the haloalkyl-linked fluorophore in, e.g., pure water or in aqueous solutions such as those that further include a buffer, a salt, a protein, a reducing agent, a surfactant, or the like, or any combination of such components. n some embodiments, the composition increases the reconstitution rate of the haloalkyl-linked fluorophore in, e.g., an aqueous buffer such as phosphate-buffered saline (PBS) at a pH of about 6.5 to about 7.5 (e.g., at a pH of about 6.5, 6.6, 6.7, 6.8, 6.9, 7.0, 7.1, 7.2, 7.3, 7.4, or 7.5, or any range therebetween) or in another suitable buffer. n some embodiments, the composition increases the solubility of the compound in, e.g., biological or environmental fluids such as a biological sample from a subject, culture media (e.g., tissue culture media), or the like.

The compositions can have any combination of the properties disclosed herein. For example, a composition may have increased solubility as described herein, an improved reconstitution rate as described herein, increased stability as described herein, and/or an increased half-life as disclosed herein. A composition may have one of the disclosed characteristics or any combination of the disclosed characteristics and may further have other improved properties.

In embodiments of the methods described herein, the contacting step may comprise the steps of: dissolving the haloalkyl-linked fluorophore in a first solvent to form a first solution; mixing the first solution with a poloxamer and/or a paper or fiber matrix to form a mixture; and drying the mixture. In some embodiments, the contacting step comprises the steps of: dissolving the haloalkyl compound in a first solvent to form a first solution; dissolving the poloxamer in a second solvent to form a second solution; mixing the first solution and the second solution to form a mixture; and drying the mixture. In some embodiments, the contacting step comprises the steps of: dissolving the haloalkyl compound in a solvent to form a first solution; applying the first solution to the paper or fiber matrix; and drying the paper or fiber matrix. In some embodiments, the contacting step comprises the steps of: dissolving the compound in a first solvent to form a first solution; dissolving the poloxamer in a second solvent to form a second solution; combining the first solution and the second solution to form a third solution; applying the third solution to a paper or fiber matrix; and drying the paper or fiber matrix.

In some embodiments, the drying step comprises lyophilization. In some embodiments, the drying step comprises air-drying. In some embodiments, the drying step comprises drying at ambient temperature under an inert atmosphere (e.g., under nitrogen or argon). In some embodiments, the drying step comprises drying at elevated temperatures (e.g., 30° C.). In some embodiments, the drying step comprises vacuum drying. In some embodiments, one or all of the solutions used in the methods may be deoxygenated. Deoxygenation can be achieved by degassing the solution under vacuum, by bubbling an inert gas (e.g., nitrogen or argon) through the solution, or the like.

Compositions may be tested by using them as substrates for HALOTAG.

In certain embodiments, the compositions disclosed herein are provided as part of a kit. The composition may be contained within a single container. In some embodiments, the kit may further include a modified dehalogenases (HALOTAG), along with suitable reagents and instructions to enable a user to perform assays therewith. The kit may also include one or more buffers such as those disclosed herein. The kit may include instructions for storing the composition and/or the single container containing the composition. Instructions included in the kit of the present disclosure may be affixed to packaging material or may be included as a package insert. While instructions are typically written or printed materials, they are not limited to such. Any medium capable of storing such instructions and communicating them to an end user is contemplated by this disclosure. Such media include, but are not limited to, electronic storage media (e.g., magnetic discs, tapes, cartridges, chips), optical media (e.g., CD ROM), and the like. As used herein, the term “instructions” can include the address of an internet site that provides instructions.

### EXPERIMENTAL

Experiments were conducted during development of embodiments herein to identify polymers and/or excipients that would increase the clarity of solutions containing haloalkyl-linked fluorophores and/or increase the concentration of haloalkyl-linked fluorophore in a solution and/or present after solubilization of a dried haloalkyl-linked fluorophore. These experiments identified poloxamer as providing enhanced clarity of solutions as well as greater concentrations of multiple haloalkyl-linked fluorophores in solution.

### Example 1

Experiments were conducted during development of embodiments herein to demonstrate the lyophilization and reconstitution of compositions herein comprising haloalkyl-fluorophore compounds and a polymer excipient.

Chloroalkyl-JANELIA FLUOR 554 (CA-JFX554) and Chloroalkyl-JANELIA FLUOR 650 (CA-JFX650) were separately dissolved in 100% methanol to a final 500 μM concentration. 2020 μl of the CA-JFX554 and CA-JFX650 solutions was then diluted in 101 ml of 2.5% Poloxamer407 for a final concentration of 10 μM of haloalkyl-fluorophore compound. 100 μl of the polymer/compound solution was transferred into 2 ml amber tubes for lyophilization.

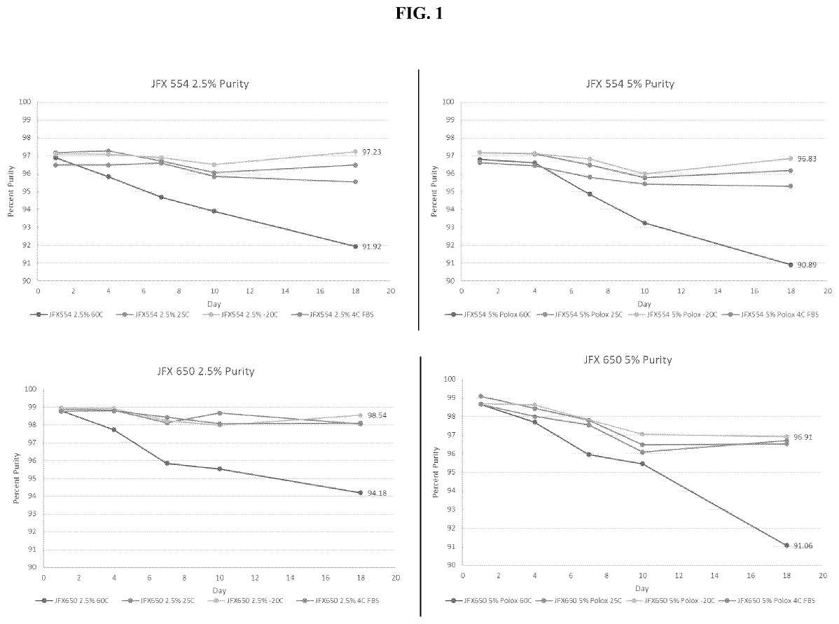

Purity of the haloalkyl-fluorophore compounds was tested (FIG. 1). After 18 days at RT, the lyophilized ligand still shows >95% purity. In addition, storage of the lyophilized ligand in FBS containing aqueous media at 4° C. also shows >95% purity after 18 days. Accelerated stability studies predict a minimum 90% purity after storage at −20 C for >4 years.

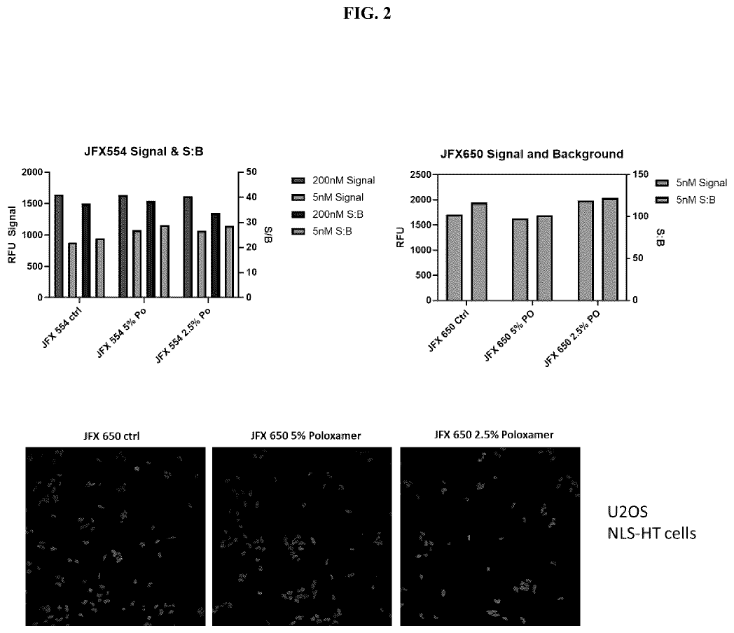

Functionality was tested by staining cells with the lyophilized ligand alongside the solid standard format of the ligand and quantifying staining intensity at saturating and sub-saturating concentrations (FIG. 2). Lyophilized ligands were dissolved by adding 1 mL of phenol red free cell culture media to the vial for a stock 1 uM solution, whereas the solid format was dissolved in DMSO for a 200 μM concentration (as the solid format is not soluble in water) and then diluted 1:200 in phenol red free cell culture media for a stock 1 uM. Dyes were added to cells at the final concentration indicated. Experiments conducted during development of embodiments herein demonstrate that that the lyophilized ligand format stains with similar intensity to the solid format at both saturating and sub-saturating concentrations using the same staining conditions (30 minutes at 37° C. with media replacement).

### Example 2

### JF Dye HaloTag Ligand Formulation

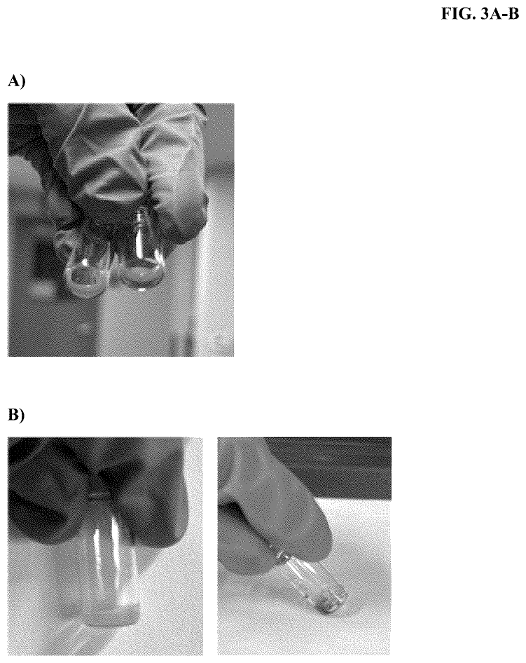

To a 100 mL round-bottom flask, 90 mg of P-407 was charged, and the P-407 was melted at 70˜75° C. while rotating. The 1 μmol JF Dye HaloTag Ligand (JF-669 or JF-552) was dissolved in ca. 3.5 mL EtOH, followed by transferring the resulting solution to the melted P-407. The resulting mixture was rotated at ca. 65° C. to afford a homogeneous solution. The resulting solution was concentrated in vacuo and re-dissolved in 10 mL MQ water. 1 mL aliquots of the resulting aqueous solution were then distributed into 10 one-dram vials, frozen, and lyophilized to afford formulated cakes (FIGS. 3A-B) containing 100 nmols of ligand per vial.

### Example 3

### JF Dye HaloTag Ligand Solubility Analysis

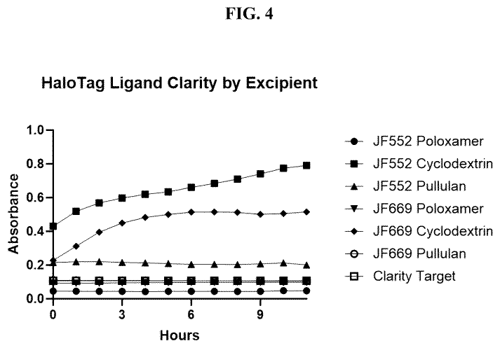

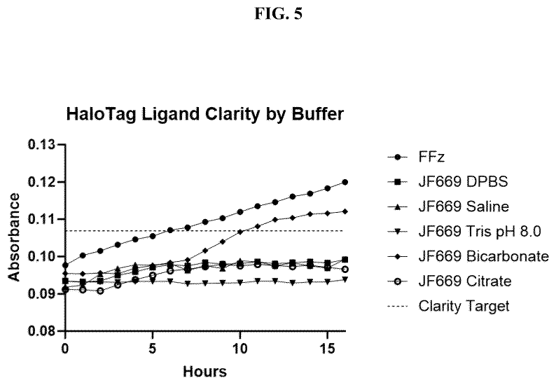

Vials of lyophilized Chloroalkyl-JANELIA FLUOR 552 (CA-JF 552) and Chloroalkyl-JANELIA FLUOR 669 (CA-JF 669) formulated prior to lyophilization with various excipients were separately dissolved in 100 μL aqueous buffer to a final 1 mM concentration. 70 μl of the CA-JF 552 and CA-JF 669 solutions were then transferred to wells of a transparent 96-well plate for clarity analysis using Optical Density absorbance measurements at 850 nm [Bandwidth 3.5 nm] (OD850) on Tecan Spark plate reader (FIGS. 4 and 5). Target absorbance limit for clarity measurements was determined using a known turbidity sample of material similarly formulated with poloxamer to assess solubility of the ligand.

A clarity target of <0.1 was utilized. Experiments conducted during development of embodiments herein demonstrated that visual clarity of a sample corresponds with an absorbance reading below 0.1.

### Example 4

### JF Dye HaloTag Ligand Stability Analysis

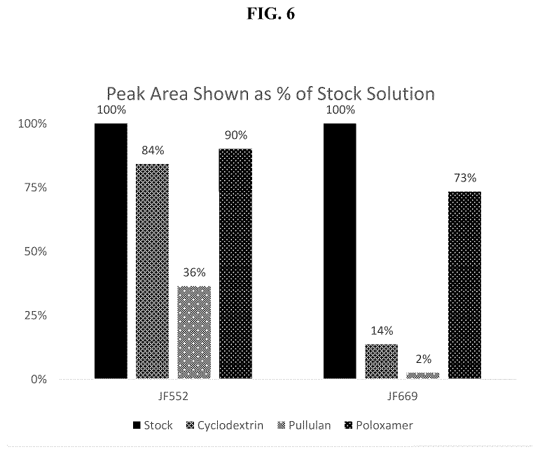

Vials of lyophilized Chloroalkyl-JANELIA FLUOR 552 (CA-JF 552) and Chloroalkyl-JANELIA FLUOR 669 (CA-JF 669) formulated in various excipients were separately dissolved in 100 μL aqueous buffer to a final 1 mM concentration. HPLC analysis of the haloalkyl-fluorophore compounds was tested to determine amount of HaloTag Ligand in solution using a comparison of peak area of Ligand peak at 254 nm. HPLC testing was run using ThermoFisher Vanquish HPLC, ThermoFisher Accucore RP-MS 50×2.6 mm 2.1 um reverse phase HPLC Column, 0.1% aqueous solution of Trifluoracetic acid/Acetonitrile mobile phase, and 30° C. column oven temperature. Measurements were taken after complete dissolution of material in Corning DPBS pH 7.0 and compared to the initial ethanol stock solution used to make formulated ligands (FIG. 6) to ensure stability of the HaloTag Ligand after lyophilization.

### Example 5

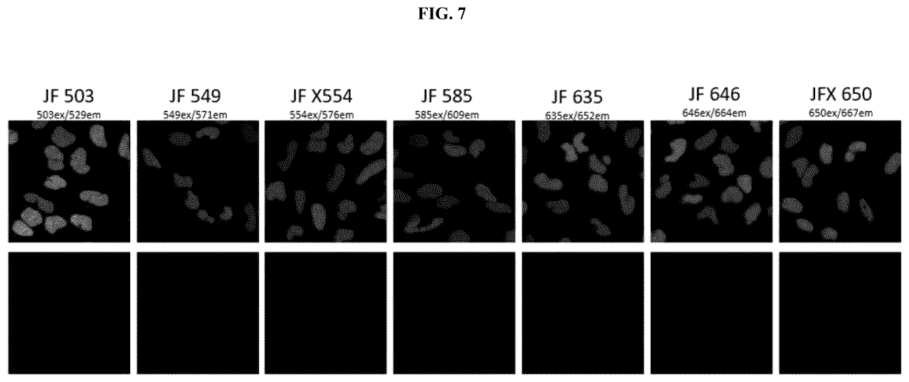

Functionality of an array of formulated and lyophilized HaloTag® Ligands that emit and excite across the UV/VIS spectrum were tested by staining cells stably expressing HaloTag® localized to the nucleus in parallel with parental cells that do not express HaloTag®. Lyophilized ligands were dissolved by adding 1 mL of phenol red free cell culture media to the vial for a 1 μM stock solution. Dyes were added to cells at the final concentration of 200 nM. Experiments conducted during development of embodiments herein demonstrate that that the formulation of lyophilized HaloTag® Ligand in poloxamer functions for an array of fluorescent HaloTag® Ligands across the UV-VIS spectrum (FIG. 7).

1. A composition comprising:
(a) a haloalkyl-linked fluorophore comprising the formula R-linker-A-X, wherein R is a fluorophore, wherein the linker is a multiatom straight or branched chain, A is (CH₂)₄₋₂₀, and X is a halide; and
(b) a poloxamer.

2-3. (canceled)

4. The composition of claim 1, wherein the fluorophore is a rhodamine dye.

5. The composition of claim 4, wherein the rhodamine dye is selected from wherein the rhodamine dye is selected from:

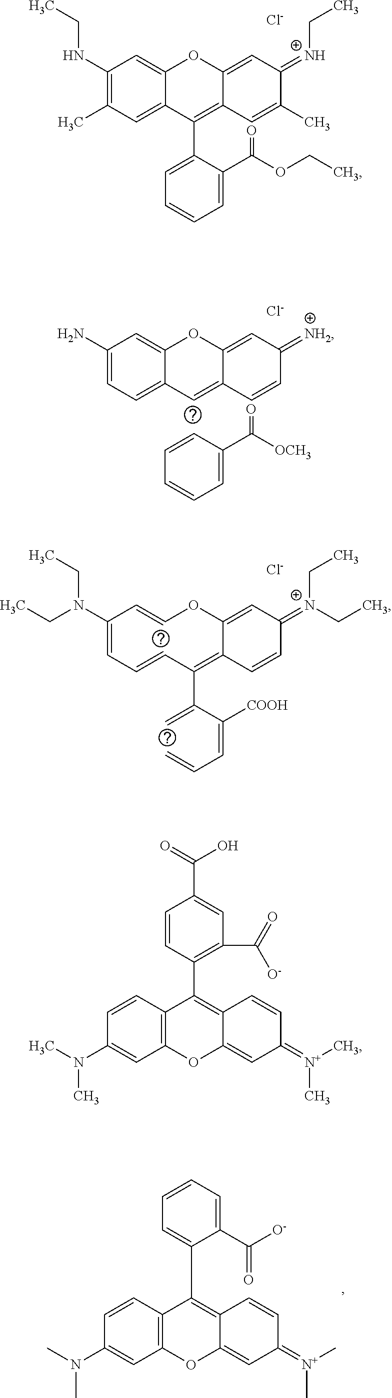

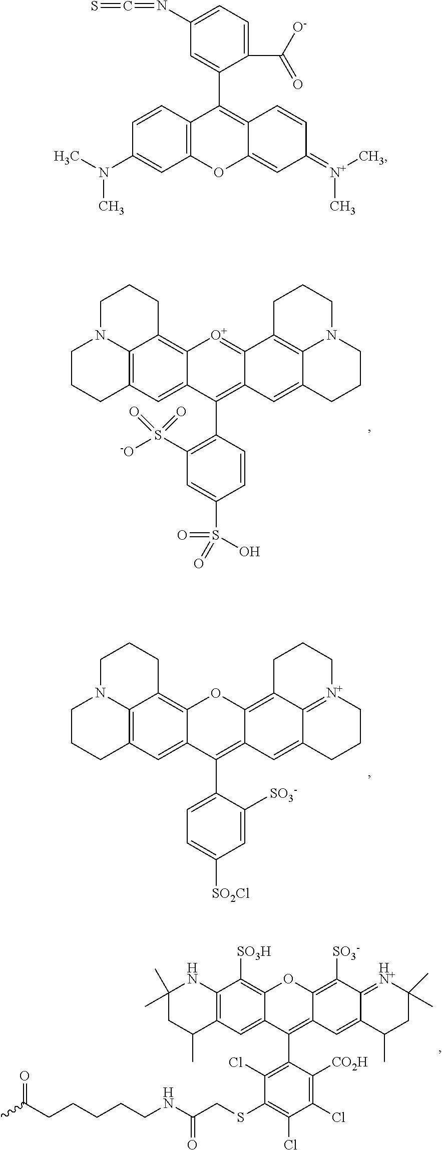

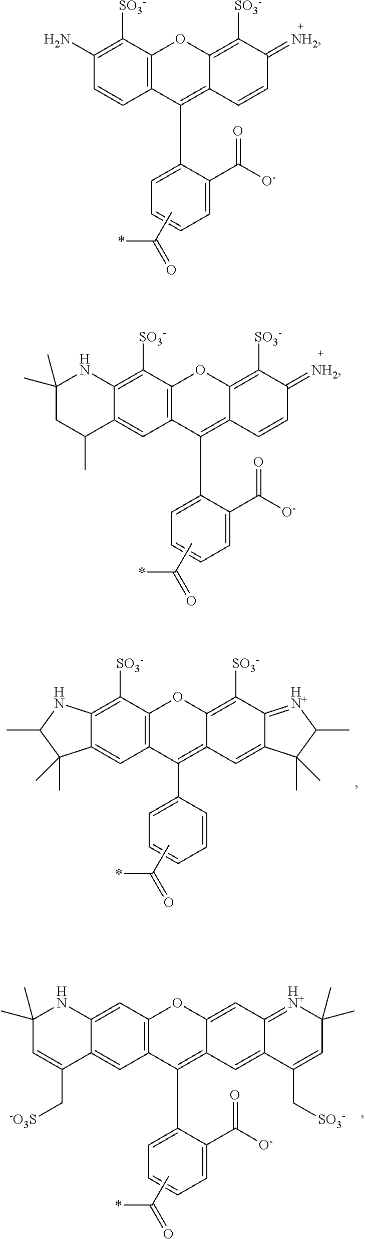

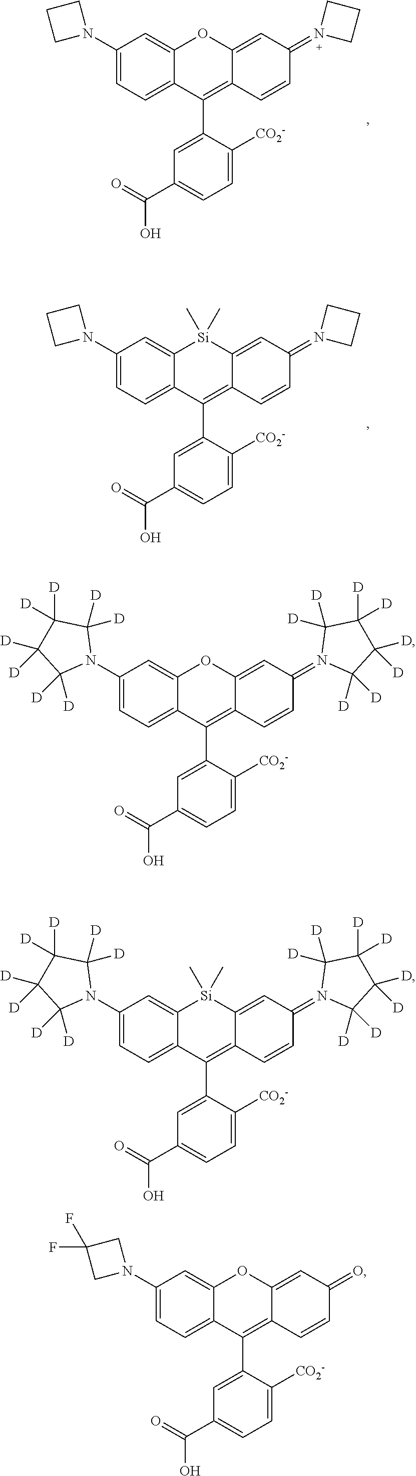

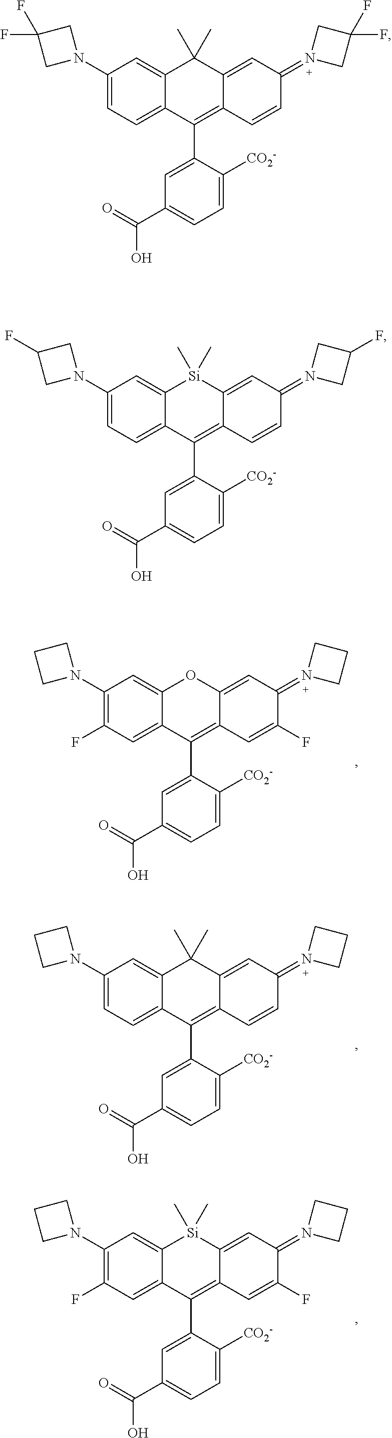

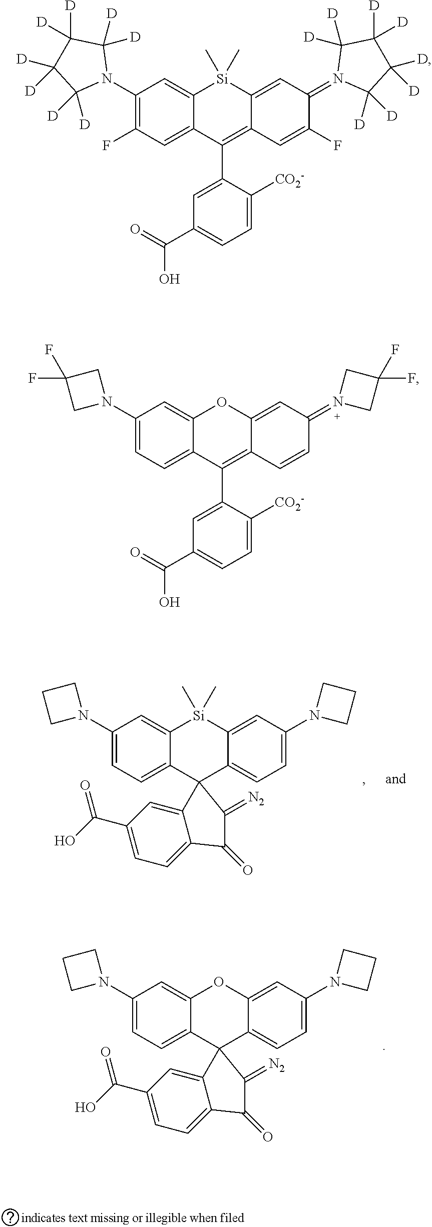

6. The composition of claim 1, wherein the wherein the linker is a multiatom straight or branched chain including C, N, S, or O, that optionally comprises one or more rings.

7. The composition of claim 6, wherein the linker comprises a cleavable moiety.

8. The composition of claim 7, wherein the cleavable moiety is selected from an allyl-heteroatom group and a propargyl-heteroatom group.

9. The composition of claim 1, wherein the poloxamer is selected from poloxamer 101, poloxamer 105, poloxamer 108, poloxamer 122, poloxamer 123, poloxamer 124, poloxamer 181, poloxamer 182, poloxamer 183, poloxamer 184, poloxamer 185, poloxamer 188, poloxamer 212, poloxamer 215, poloxamer 217, poloxamer 231, poloxamer 234, poloxamer 235, poloxamer 237, poloxamer 238, poloxamer 282, poloxamer 284, poloxamer 288, poloxamer 331, poloxamer 333, poloxamer 334, poloxamer 335, poloxamer 338, poloxamer 401, poloxamer 402, poloxamer 403, and poloxamer 407.

10. The composition of claim 9, wherein the poloxamer is poloxamer 407.

11. The composition of claim 1, further comprising a buffer, a surfactant, a reducing agent, a salt, a radical scavenger, a protein, or any combination thereof.

12. The composition of claim 11, wherein the buffer is selected from a phosphate buffer, tricine, and 2-(N-morpholino) ethanesulfonic acid.

13. The composition of claim 11, wherein the surfactant is selected from polysorbate 20, polysorbate 40, and polysorbate 80.

14. The composition of claim 11, wherein the reducing agent is selected from thiourea and 6-aza-2-thiothymine.

15. The composition of claim 11, wherein the salt is selected from sodium chloride and sodium phosphate.

16. The composition of claim 11, wherein the radical scavenger agent is selected from ascorbic acid and sodium ascorbate.

17. The composition of claim 11, wherein the chelating agent is selected from citric acid and trans-1,2-diaminocyclohexane-tetraacetic acid.

18. The composition of claim 11, wherein the protein is selected from bovine serum albumin, gelatin, and a polypeptide fraction of highly purified dermal collagen of porcine origin.

19. The composition of claim 1, wherein the composition is in the form of a lyophilized powder, cake, or malleable film.

20. The composition of claim 1, wherein the composition is a solution.

21. The composition of claim 19, wherein the haloalkyl-linked fluorophore is stabilized against thermal decomposition, chemical decomposition, light-induced decomposition, or any combination thereof.

22. A method of storing a haloalkyl-linked fluorophore comprising the formula R-linker-A-X, wherein R is a fluorophore, wherein the linker is a multiatom straight or branched chain, A is (CH₂)₄₋₂₀, and X is a halide, the method comprising contacting the compound with a poloxamer.

23-32. (canceled)
